(19) United States
(12) Patent Application Publication
(10) Pub. No.: US 2025/0370273 A1
(43) Pub. Date: Dec. 4, 2025

(54) TIME DIVISION MULTIPLEXING FOR LIGHT FIELD DISPLAY

(71) Applicant: Avalon Holographics Inc., St. John’s (CA)

(72) Inventor: Andrew Bartlett, St. John's (CA)

(21) Appl. No.: 18/731,533

(22) Filed: Jun. 3, 2024

(51) Int. Cl. G02B 30/10; G02B 27/28; G02F 1/01

(52) U.S. Cl. CPC G02B 30/10; G02B 27/286; G02F 1/0136

(57) ABSTRACT

An optical time domain multiplexing system and method of driving a time division multiplexed light field display to output a multiplexed light field image. The time domain multiplexing device for use in light field display comprises a series of optical components to manipulate the polarization of light, resulting in independent time states to create a multiplexed light field display.

### FIELD OF THE INVENTION

The present disclosure relates to light field display technology and more specifically, to methods of time division multiplexing (TDM) and optical components for holographic displays. The present disclosure particularly relates to a system and method for multiplexing a multiple view, light field display, resulting in high angular resolution and a wide field of view (FoV).

### BACKGROUND OF THE INVENTION

Light field displays provide multiple views, allowing a user to receive a separate view in each eye. A light field display without eye tracking offers significant advantages in terms of user experience, accessibility, and practicality. It provides a simpler and more comfortable viewing experience, free from the intrusiveness and discomfort that eye tracking hardware and software can introduce. Such displays are more accessible to a wider audience, eliminating the need for specific technological proficiency or physical accommodations. Additionally, they offer enhanced reliability and consistency by avoiding the inaccuracies that can plague eye tracking systems due to lighting, movement, or calibration issues. The absence of eye tracking also reduces the overall cost and complexity, making the technology more affordable and easier to integrate into various applications. Furthermore, these displays are straightforward to use, requiring no additional setup or calibration, allowing users to interact with them immediately. Overall, light field displays without eye tracking provide a more intuitive, accessible, and reliable solution for delivering immersive visual experiences.

While current displays in this category provide an interesting viewing experience, a captivating light field display requires a high pixel density, low angular separation between views, and a large viewing angle. For a high-quality viewing experience, it is desired that a user experiences smooth transitions between viewing zones while maintaining an independent and perceivable view from the adjacent views. Three-dimensional light field displays allow the viewer to gain a broader perspective on the image they are viewing. Some three-dimensional displays use polarized light and require the viewer to wear specialized glasses. Others produce an image that provides some parallax in a single dimension.

High resolution light field displays require small scale (nano- or micro-scale) pixels. When used in a display, a reduced pixel size allows the system to output a greater number of light beams, allowing the generation of higher angular resolution displays with improved spatial resolution of multi-dimensional objects. Fabrication of nano- or micro-scale pixels is new and challenging. Additionally, to produce the increased number of light-field display views required to allow a viewer located at any viewing position to simultaneously receive multiple views, the light emitted by each pixel must be directionally controlled with a high degree of precision and accuracy.

U.S. Pat. No. 10,244,230 to Haas et al. describes a directional pixel for a high-angular resolution, wide field of view, multiple view display. The design teaches a directional pixel comprising a substrate, one or more pixel driving circuits, one or more nano- or micro-scale subpixels, and one or more directional optical guiding surfaces, wherein each of said one or more subpixels is comprised of a light emitting device emitting a light beam and an optical microcavity housing said light emitting device. The optical microcavity is comprised of a plurality of reflective surfaces to specifically manipulate and tune said light beam, wherein one or more of said reflective surfaces is a light propagating reflective surface which propagates said light beam out of said microcavity, and said light propagating reflective surface is connected to said one or more directional optical guiding surfaces to direct said light beam at a specific angle.

An alternative to generating the multiple views required for a high-quality light field display at the pixel may include implementation of a multiplexing technique. Multiplexing allows for the transmission of several signals over a common channel. One example is time division multiplexing (TDM), which is a technique wherein a complete signal is transmitted over a common channel while occupying separate time slots. In TDM, a time division technique is performed by synchronizing switches at each end of the transmission line so that each signal appears on the line only a fraction of time in an alternating pattern to produce a multiplexed data signal.

United States patent application publication number US2022/0179193 to Bevensee et al. describes an energy directing system with one or more energy sources and a plurality of energy directing surfaces configured to direct incident energy along a plurality of energy propagation paths in a time-sequential manner. Bevensee et al. teaches that modules having an energy source (such as a laser) and an energy-deflecting surface (such as a micromirror) can be used to project many 4D propagation paths per interval of time.

The density of views produced by a light field display may be increased through the dynamic manipulation of the polarization state of light combined with polarization sensitive optical components enabling TDM of light field content. Polarizing optical components, which include but are not limited to polarizers, liquid crystal devices, phase retarders, and Pancharatnam-Berry optical elements, are examples of optical components that can manipulate the polarization state of light. An optical stack of these devices can not only control the final polarization state of transmitted light, but also the transmission and directivity of the stack, or how much light is being transmitted and in what direction.

In another example, United States patent application publication number US2022/0187529 to El-Ghoroury et al. describes a method and apparatus for achieving selective polarization states of emitted visible or other light in a stacked multicolor emissive display device by utilizing nonpolar, semipolar, or strained c-plane crystallographic planes of semiconductor materials for light emitting structures within an electronic emissive display device. However, exploiting light polarization heavily impacts system efficiency as, in addition to the expense of implementing multiple polarization sensitive optical components into a display, the initial polarization of light from an organic light emitting diode light source discards 50% of the light produced.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

It is an object of the present invention to provide a device, optical system, and method of creating a time division multiplexing (TDM) light field display. It is another object to provide a TDM light field display that uses light polarization components and techniques to produce high resolution pixel density in a light field.

In an aspect there is provided a device for displaying a time multiplexed light field comprising: a pixel array; a time division multiplexing system; and a directional optical element.

In an embodiment, the time division multiplexing system comprises a polarization sensitive optical system and a polarization sensitive beam deflector.

In another embodiment, the polarization sensitive optical system comprises: a circular polarizer comprising a quarter wave plate for receiving incoming light and providing a circularly polarized light beam; a circular polarization switcher comprising a switchable half wave plate; and a control system for controlling current to the circular polarization switcher.

In another embodiment, the circular polarizer further comprises a linear polarizer before the quarter waveplate.

In another embodiment, the linear polarizer comprises an absorptive polarizer, beam-splitting polarizer, linear polarizing film, dichroic polarizer, wire grid polarizers, birefringent polarizer, or dichroic polymer thin film polarizer.

In another embodiment, the circular polarization switcher is a switchable liquid crystal half wave plate.

In another embodiment, the circular polarization switcher comprises a liquid crystal cell comprising: a substrate; a first electrode; an alignment layer; a liquid crystal material; and a second electrode.

In another embodiment, the circular polarization switcher comprises a birefringent material selected from one of liquid crystals, quartz, and magnesium fluoride.

In another embodiment, the circular polarization switcher comprises a switchable liquid crystal half wave plate comprising a liquid crystal material comprising one or more of a birefringent material and a thermotropic material with a rod-like molecular shape.

In another embodiment, the polarization sensitive beam deflector comprises a birefringent material element, liquid crystal device, polarizing beam splitter, electro-optic or acousto-optic device, chromatic beam deflector, achromatic beam deflector, or Pancharatnam-Berry optical element.

In another embodiment, the directional optical element comprises one or more of a lens, lens array, mirror, prism, diffraction grating, waveguide, optical fiber, beam splitter, metasurface, and metalens.

In another embodiment, the linear polarizer is designed for maximum efficiency versus extinction ratio, p.

In another aspect there is provided a method for creating a time multiplexed light field comprising: receiving a light beam from a pixel array; deflecting the light beam by a deflection angle; and directing the deflected light beam at a directional optical element to generate a light field.

In an embodiment, the method further comprises transforming the light beam received from the pixel array into a linearly polarized light beam.

In another embodiment, the method further comprises transforming the linearly polarized light beam into a circularly polarized light beam having a rotational handedness.

In another embodiment, the method further comprises, at a circular polarization switcher, reversing the rotational handedness of the circularly polarized light beam or retaining the rotational handedness of the circularly polarized light beam.

In another embodiment, the circularly polarized light beam is deflected and directed to the directional optical element to generate the light field.

In another embodiment, the deflection angle is based on a rotational handedness of the circularly polarized light beam.

In another embodiment, the deflected light beam shifts a virtual pixel position by a factor of one or more of one half of an angular pitch ((/2) and one quarter of the angular pitch ((/4) of pixels in the pixel array.

In another embodiment, the circular polarization switcher is a switchable liquid crystal half wave plate, and wherein retaining the rotational handedness comprises applying a threshold voltage to the switchable liquid crystal half wave plate sufficient to retain the handedness of the circularly polarized light beam.

In another embodiment, deflecting the circularly polarized light beam angle comprises receiving the circularly polarized light beam at a polarization sensitive beam deflector, the polarization sensitive beam deflector configured to deflect the circularly polarized light beam of a first handedness by a first angle in a first direction and to deflect the circularly polarized light beam of the reversed handedness by a second angle in a second direction.

In another embodiment, the light beam is received from a Light Emitting Diode (LED), projector device, Organic Light Emitting Diode (OLED), active-matrix organic light emitting diode (AMOLED) array, or electroluminescent (EL) device.

In another aspect there is provided a time division multiplexing (TDM) optical system comprising: a pixel array comprising a plurality of pixels, each pixel in the pixel array generating a light beam; a circular polarizer comprising: a linear polarizer for receiving the light beam and providing a linearly polarized light beam; and a quarter wave plate for receiving the linearly polarized light beam and providing a circularly polarized light beam; a circular polarization switcher for receiving the circularly polarized light beam and alternately switching between a first circularly polarized light beam of a first handedness and a second circularly polarized light beam of a second handedness, the circular polarization switcher connected to a control system to control current to the circular polarization switcher; a polarization sensitive beam deflector configured to deflect the circularly polarized light based on its handedness; and a directional optical element configured to receive the deflected circularly polarized light from the polarization sensitive beam deflector and generate a light field.

In an embodiment, the pixel array is in an active-matrix organic light emitting diode (AMOLED) array.

In another embodiment, the circular polarization switcher alternates between the circularly polarized light beam of the first handedness and the second circularly polarized light beam of the second handedness at least every 30 Hz.

In another embodiment, the polarization sensitive beam deflector comprises a birefringent material element, liquid crystal device, polarizing beam splitter, electro-optic or acousto-optic device, chromatic beam deflector, achromatic beam deflector, or Pancharatnam-Berry optical element.

In another embodiment, the polarization sensitive beam deflector is a controllable polarization sensitive beam deflector that can further control the deflection angle of the emitted light beam.

In another embodiment, the controllable polarization sensitive beam deflector is a controllable Pancharatnam-Berry (PB) beam deflector.

In another embodiment, the polarization sensitive beam deflector is connected to an electrical current source.

In another embodiment, the controllable polarization sensitive beam deflector is connected to an electrical current source.

In another embodiment, the system further comprises a linear polarization switcher configured to receive and alter an orthogonal orientation of the linearly polarized light beam.

In another embodiment, the linear polarization switcher is an Electro-Optic Modulator (EOM), Liquid Crystal Device (LCDs), Acousto-Optic Modulator (AOM), Magneto-Optic Modulator, Mechanical Polarization Switch, or Digital Polarization Rotator.

In another embodiment, the linear polarization switcher switches a plane of linearly polarized light by +/−45°.

In another aspect there is provided a time division multiplexing (TDM) optical system comprising: a linear polarization switcher connected to a control system configured to receive a linearly polarized light beam and alternately switch between the linearly polarized light beam between a first orthogonal direction and a second orthogonal direction; a quarter wave plate for receiving the linearly polarized light beam and providing a circularly polarized light beam; a circular polarization switcher for receiving the circularly polarized light beam and alternately switching between a first circularly polarized light beam of a first handedness and a second circularly polarized light beam of a second handedness, the circular polarization switcher connected to a control system to control current to the circular polarization switcher; a polarization sensitive beam deflector configured to deflect the circularly polarized light based on its handedness; and a directional optical element configured to receive the deflected circularly polarized light from the polarization sensitive beam deflector and generate a light field.

In another aspect there is provided a device for light beam multiplexing comprising: a circular polarizer comprising a quarter wave plate for receiving incoming light and providing a circularly polarized light beam; a circular polarization switcher comprising a switchable half wave plate; a control system for controlling current to the circular polarization switcher; a polarization sensitive beam deflector; and a directional optical element.

In another aspect there is provided a method for creating a multiplexed light field comprising: receiving a light beam from a pixel array; transforming the light beam into a linearly polarized light beam; transforming the linearly polarized light beam into a circularly polarized light beam having a rotational handedness; receiving the circularly polarized light beam at a circular polarization switcher, and either reversing the rotational handedness of the circularly polarized light beam or retaining the rotational handedness of the circularly polarized light beam; deflecting the circularly polarized light beam at a deflection angle based on the rotational handedness of the circularly polarized light beam; and directing the circularly polarized light beam at a directional optical element to generate a light field.

In another aspect there is provided a time division multiplexing (TDM) optical system comprising: a pixel array comprising a plurality of pixels, each pixel in the pixel array generating a light beam; a circular polarizer comprising: a linear polarizer for receiving the light beam and providing a linearly polarized light beam; and a quarter wave plate for receiving the linearly polarized light beam and providing a circularly polarized light beam; a circular polarization switcher for receiving the circularly polarized light beam light beam and alternately switching between a circularly polarized light beam of a first handedness and a second circularly polarized light beam of a second handedness, the circular polarization switcher connected to a control system to control current to the circular polarization switcher; a polarization sensitive beam deflector configured to deflect the circularly polarized light based on its handedness; and a polarization insensitive directional optical element configured to receive the deflected circularly polarized light from the polarization sensitive beam deflector and generate a light field.

### BRIEF DESCRIPTION OF THE DRAWINGS

These and other features of the invention will become more apparent in the following detailed description in which reference is made to the appended drawings.

FIG. 1 illustrates a cross-section of the ray path of individual pixels of a pixel array with an associated directional optical element.

FIG. 2A illustrates a cross-section of the ray path of individual pixels of a 2D pixel array with directional optical element and an associated focal plane, illustrating three ray paths per pixel.

FIG. 2B illustrates a ray path diagram of a single pixel in a pixel array with a directional optical element.

FIG. 3 illustrates a cross-section of the ray path of an individual pixel in a pixel array to a beam deflector.

FIG. 4 illustrates a cross-section of the ray path of an individual pixel in a pixel array with forward and backward ray path tracing to and from a plane parallel to the pixel array through a beam deflector.

FIG. 5 illustrates a cross-section of the ray path of a single pixel in a pixel array in a time division multiplexing system.

FIG. 6A illustrates a cross-section of the ray paths for light emitted from individual pixels in a pixel array through a time domain multiplexing system where the apparent origin of each pixel is shifted to the left relative to the actual location of each pixel in the pixel array.

FIG. 6B illustrates a cross-section of the ray paths for light emitted from individual pixels in a pixel array through a time domain multiplexing system where the apparent origin of each pixel is shifted to the right relative to the actual location of each pixel in the pixel array.

FIG. 7A illustrates a map of an ideal directional array for a 1×TDM display.

FIG. 7B illustrates a map of an ideal directional array for a 2×TDM display.

FIG. 7C illustrates a map of an ideal directional array for a 4×TDM display.

FIG. 8 illustrates components of a time division multiplexing device and transformation of the light by each component.

FIG. 9 illustrates light polarization transformation of light rays through an example time division optical multiplexing system in the T1 state.

FIG. 10 illustrates linear polarizations of incident light defined by their relative orientation to the plane of incidence.

FIG. 11 illustrates light polarization transformation of light rays through an example time division optical multiplexing system in the T2 state.

FIG. 12 illustrates the ray paths for three subpixels in the T1 and T2 states of an embodiment of a time domain multiplexing optical system.

FIG. 13A is a geometric illustration of a linear phase mask.

FIG. 13B illustrates a linear phase gradient for a Pancharatnam-Berry Beam Deflector (PBBD).

FIG. 14 illustrates a wavefront transmitted by the PBBD using Huygens principle for both right-hand circularly polarized light (RHCPL) and left-hand circularly polarized light (LHCPL).

FIG. 15A illustrates a portion of a time domain multiplexing optical system showing the ray path of a red subpixel and green subpixel in TDM states T1 and T2.

FIG. 15B illustrates a portion of an alternative embodiment of a time domain multiplexing optical system for the ray path of a red and green subpixel in TDM states T1 and T2.

FIG. 15C illustrates a portion of another embodiment of the disclosed optical system for the ray path of a red and green subpixel in TDM state T3.

FIG. 16A illustrates a triplet of three monochromatic sub-hogels.

FIG. 16B illustrates a metasurface design for a triplet of three sub-hogels.

FIG. 17A illustrates a plan view of a metasurface design in an embodiment of the present disclosure.

FIG. 17B illustrates an isometric view of a metasurface design in an embodiment of the present disclosure.

FIG. 18 is a flowchart illustrating a method of creating a time domain multiplexed light field display.

FIG. 19 illustrates components of a time division multiplexing device and transformation of the light by each component for an incoming polarized light source.

FIG. 20 illustrates components of a time division multiplexing device and transformation of the light by each component for an incoming linearly polarized light source with optional orthogonal angle switching.

FIG. 21 illustrates components of a time division multiplexing device for incoming linearly polarized light and transformation of the light by each component.

### DETAILED DESCRIPTION OF THE INVENTION

Unless defined otherwise, all technical and scientific terms used herein have the same meaning as commonly understood by one of ordinary skill in the art to which this invention pertains.

The use of the word “a” or “an” when used herein in conjunction with the term “comprising” may mean “one,” but it is also consistent with the meaning of “one or more,” “at least one” and “one or more than one.”

As used herein, the terms “comprising,” “having,” “including” and “containing,” and grammatical variations thereof, are inclusive or open-ended and do not exclude additional, unrecited elements and/or method steps. A composition, device, article, system, use, or method described herein as comprising certain elements and/or steps may also, in certain embodiments consist essentially of those elements and/or steps, and in other embodiments consist of those elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to.

The recitation of ranges herein is intended to convey both the ranges and individual values falling within the ranges, to the same place value as the numerals used to denote the range, unless otherwise indicated herein.

The use of any examples or exemplary language, e.g., “such as”, “exemplary embodiment”, “illustrative embodiment” and “for example” is intended to illustrate or denote aspects, embodiments, variations, elements or features relating to the invention and is not intended to limit the scope of the invention.

As used herein, the terms “connect” and “connected” refer to any direct or indirect physical association between elements or features of the present disclosure. Accordingly, these terms may be understood to denote elements or features that are partly or completely contained within one another, attached, coupled, disposed on, joined together, in communication with, operatively associated with, etc., even if there are other elements or features intervening between the elements or features described as being connected.

As used herein, the term “pixel”, short for “picture element”, refers to the smallest unit of a digital image or display that can be individually controlled or manipulated. Each pixel can produce varying levels of brightness and color, typically by combining subpixels of different intensities, i.e., red, green, and blue.

As used herein, the term “subpixel” refers to a light emitting unit that makes up a pixel. The present disclosure provides for individually addressable red, green, and blue (RGB) subpixels. The subpixel size as presently described is in a nanoscale to several microns range.

As used herein, the term “virtual pixel” refers to a conceptual or software-defined pixel that is part of a larger grid or set of data points. Unlike physical pixels, which are the smallest discrete elements on a physical display screen or imaging sensor, virtual pixels represent an abstraction or a calculated unit within a digital representation.

As used herein, the term “light field” at a fundamental level refers to a function describing the amount of light flowing in every direction through points in space, free of occlusions. Therefore, a light field represents radiance as a function of position and direction of light in free space. A light field can be synthetically generated through various rendering processes or may be captured from a light field camera or from an array of light field cameras.

As used herein, the term “light field display” is a device which reconstructs a light field from a finite number of light field radiance samples input to the device. The radiance samples generally comprise the color components red, green and blue (RGB) which originate from light emitting diodes (LEDs) of the same color. For reconstruction in a light field display, a light field can also be understood as a mapping from a four-dimensional space to a single RGB color. The four dimensions include the vertical and horizontal dimensions of the display and two dimensions describing the directional components of the light field. A light field can be defined as the function:

(x,y,u,v)→(r,g,b) LF:

For a fixed point x_{f}, y_{f} in the light field, where LF(x_{f}, y_{f}, u, v) represents a two-dimensional (2D) image referred to as an “elemental image”. The elemental image is a directional image of the light field from the fixed x_{f}, y_{f} position. When a plurality of elemental images are connected side by side, the resulting image is referred to as an “integral image”. The integral image can be understood as the entire light field required for the light field display.

As used herein, the acronym “FWHM” refers to “Full-Width at Half Maximum”, which is an expression of the extent of a function given by the difference between the two extreme values of the independent variable at which the dependent variable is equal to half of its maximum value.

As used herein, the term “hogel” is an alternative term for a holographic pixel, which is a cluster of traditional pixels with directional control. An array of hogels can generate a light field. As a pixel describes the spatial resolution of a two-dimensional display, a holographic pixel or hogel describes the spatial resolution of a three-dimensional display.

As used herein, the term “light beam” is understood to originate from a light source. A light beam comprises a plurality of light rays.

As used herein, the term “viewing angle” refers to the angle over which a hogel has direction control in either yaw or pitch.

As used herein, the term “hogel pitch” refers to the distance from the center of one hogel to the center of an adjacent hogel.

As used herein, the term “OLED” refers to an Organic Light Emitting Diode, which is an opto-electronic device which emits light under the application of an external voltage. OLEDs have an emissive electroluminescent layer or organic material or species that emits light in response to an electric current. OLEDs can be divided into two main classes: those made with small organic molecules and those made with organic polymers. Without being bound by theory, when a current is applied, the anode injects holes and the cathode injects electrons into the organic layers. The injected holes and electrons each migrate toward the oppositely charged electrode. When an electron and hole localize on the same molecule, an exciton, which is a localized electron-hole pair having an excited energy state, is formed. Light is emitted when the exciton relaxes via a photo emissive mechanism. Types of OLED include but are not limited to Active-matrix OLEDs (AMOLED) and Passive-matrix OLEDs (PMOLED). AMOLEDs have full layers of cathode, organic molecules, and anode. The anode layers have a thin film transistor (TFT) plane in parallel to it so as to form a matrix. This helps in switching each pixel to its on or off state as desired, thus forming an image. Hence, the pixels can be switched off whenever they are not required or there is a black image on the display, decreasing the energy required to illuminate the display. This is the least power consuming type of OLED and has quicker refresh rates which makes them suitable for video. PMOLEDs have a similar composition to AMOLEDs but the cathode lines are arranged at right angles to the anode lines. The electrical control is achieved through the anode and cathode lines to activate the pixel at the intersection point, generating light. The display background of a PMOLED is always black while the color displayed when the pixel is turned on is a predetermined color. PMOLED pixels are fixed to a single color and are not generally suitable for dynamic imagery or displays. OLEDs may be top or bottom emitting. Top-emitting OLEDs have a substrate that is either opaque or reflective. An OLED is bottom emitting if the emitted light passes through the transparent or semi-transparent bottom electrode and substrate. Top-emitting OLEDs are generally better suited for active-matrix applications as they can be more easily integrated with a non-transparent transistor backplane.

As used herein, the term “microcavity OLED” (MCOLED) refers to the materials of an OLED, as previously described, bound in a microcavity defined by two reflective surfaces, in which the reflective surfaces can be metallic materials, dielectric materials arranged in such a way to reflect light within a specific range, or a combination of dielectric and metallic materials.

As used herein, the terms “metasurface” and “optical metasurface” refer to an engineered surface used to manipulate a wavefront. The engineered surface in a metasurface generally consists of a two-dimensional (2D) lattice or pattern of nanostructures that interact with an impinging wavefront where the lattice constant and structure size are subwavelength. The characteristics of each subwavelength nanostructure are selected to impart a specific local phase and amplitude onto the wavefront. By controlling the phase and amplitude of the wavefront at each lattice site, the shape of the wavefront can be manipulated. Metasurfaces can be designed for various types of wavefront, including but not limited to electromagnetic and acoustic wavefronts. Optical metasurfaces operate on light waves and can be used to flatten existing three-dimensional (3D) components such as lenses. Optical metasurfaces can also be fabricated using semiconducting techniques thus reducing fabrication costs.

As used herein, the term “pixel pitch” refers to the distance from the center of one pixel to the center of the next pixel in a pixel array. It then follows that the hogel pitch is defined as the distance from the center of one hogel to the center of an adjacent hogel.

As used herein, the term “pixel array” refers to an array of pixels which are optionally inside a hogel.

As used herein, the term “polarizer” refers to an optical component capable of controlling or changing the polarization of incoming light, and transmitting a desired polarization state while reflecting, absorbing or deviating the rest. There are a wide variety of polarizer designs, each with its own advantages and disadvantages. Polarizers are defined by a few key parameters, two of which being the extinction ratio and degree of polarization. The polarizing properties of a linear polarizer are typically defined by the degree of polarization or polarization efficiency, P, and its extinction ratio, pp. The extinction performance of a linear polarizer is often expressed as 1/ρρ:1. This parameter ranges from less than 100:1 for economical sheet polarizers to 10⁶:1 for high quality birefringent crystalline polarizers. The extinction ratio typically varies with wavelength and incident angle and must be evaluated along with other factors like cost, size, and polarized transmission for a given application. Polarizer types include, but are not limited to, dichroic polarizers, reflective polarizers, polarizing cubes, wire grid polarizers, birefringent polarizers, crystalline polarizers, and thin film polarizers. In one example, a dichroic polarizer transmits the desired polarization of light and absorbs the rest. This is achieved via anisotropy in the polarizer. Common examples of dichroic polarizers include oriented polymer molecules and stretched nanoparticles. By contrast, reflective polarizers transmit the desired polarization of light and reflect the rest. Birefringent polarizers transmit the desired polarization and deviate the rest and thin film polarizers work on the premise of thin film technology.

As used herein, the term “linear polarizer” refers to an optical filter that allows light waves oscillating in a specific plane to pass through while blocking or absorbing light waves oscillating in other planes. This selective filtering of light waves is based on their direction of polarization, which refers to the orientation of the electric field component of the electromagnetic wave.

As used herein, the term “quarter wave plate” refers to an optical device that converts linearly polarized light into circularly polarized light.

As used herein, the term “half wave plate” refers to an optical device that can rotate the plane of circularly polarized light, for example from one rotational handedness to the other rotational handedness.

As used herein, the term “circular polarizer” refers to a type of optical filter designed to selectively allow light waves with a specific circular polarization to pass through while blocking or altering other polarizations. A circular polarizer comprises a quarter wave plate to convert linearly polarized light into circularly polarized light, and may also comprise a linear polarizer. In the case where the circular polarizer also comprises a linear polarizer, the linear polarizer first filters the incoming light to apply a linear polarization, and the quarter-wave plate then converts the linearly polarized light into circularly polarized light. The resulting circularly polarized light can be either left-handed or right-handed, depending on the configuration of the circular polarizer.

As used herein, the term “controllable circular polarization switcher” refers to a device or system that can dynamically change the polarization state of light between two rotational handednesses, such as to and from left-handed circular polarization (LHCP) and right-handed circular polarization (RHCP). These switchers are valuable in many optical applications, including communication, displays, and quantum computing. Examples of controllable circular polarization switchers include Liquid Crystal-Based Switchers, Electro-Optic Modulators, Acousto-Optic Devices, Piezoelectric Polarization Controllers, and MEMS-Based Switchers. Liquid Crystal-Based Switchers and Liquid crystal devices, which are commonly used in displays, can switch between different polarization states by controlling the orientation of liquid crystal molecules with an electric field. In a circular polarization switcher, the liquid crystals can rotate the plane of polarization, enabling conversion between linear and circular polarization. An electric field controls whether the director of the liquid crystals falls perpendicular or parallel to the path of light, which effectively controls the axis of anisotropy of the liquid crystals refractive index. When the axis of anisotropy is parallel to the direction polarized light is travelling the polarization state is not affected as the electric field associated with the light is perpendicular to the anisotropic axis; however, when the axis of anisotropy is perpendicular to the direction polarized light is travelling the polarization state is affected as S and P polarizations experience different refractive indices. The optical path of the circular polarization switcher is proportional to its refractive indices; therefore, when S and P polarizations will have different optical paths lengths, which causes a phase shift between the polarizations state. A circular polarization switcher is designed such that the optical path difference between S and P polarized light is either 0 or half a wavelength corresponding to a phase shift of 0 or pi. This relative shift in polarization transforms RHCPL to LHCPL. These devices are widely used in optical communication and displays. In an example, electro-optic modulators use electric fields to change the refractive index of a material, allowing for dynamic control over light's polarization. By manipulating the electric field, these devices can create a phase shift that converts linear polarization to circular polarization or vice versa. This technology is commonly used in high-speed communication systems and advanced photonic devices. In another example, acousto-optic devices use sound waves to create changes in the optical properties of a medium. This modulation can induce phase shifts, which can be used to control polarization. Although less common than other methods, Acousto-Optic devices can be designed to switch between different polarization states. In another example, piezoelectric polarization controller devices use piezoelectric materials to induce mechanical stress or vibration, changing the orientation of optical components such as birefringent crystals. This alteration in stress can affect the polarization state, allowing for controlled switching between different circular polarizations. In another example, MEMS-based switchers are microelectromechanical systems (MEMS) that can be used to create polarization switchers that manipulate small optical components to change polarization states. MEMS-based switchers can be designed to have high precision and low energy consumption, ideal for compact optical systems and integrated photonics.

As used herein, the term “polarization sensitive beam deflector” refers to an optical device or system that changes the direction of a light beam based on its polarization state. The fundamental characteristic of such a deflector is its ability to distinguish between different polarizations of light and manipulate their propagation paths differently. Various methods and components can be used to create polarization-sensitive deflection including but not limited to birefringent materials, liquid crystal devices, Polarizing Beam Splitters (PBS), and electro-optic or acousto-optic devices. Birefringent materials have different refractive indices depending on the polarization of the incident light. When a beam passes through a birefringent medium, its deflection is influenced by its polarization. Liquid crystal devices use liquid crystal technology to rotate or change the polarization of light, which in turn can be used to control the deflection of the beam in conjunction with other optical components. Polarizing Beam Splitters (PBS) divide light into different paths depending on its polarization. When used in conjunction with other optical elements, this can form the basis for a polarization-sensitive deflector. Electro-optic or acousto-optic devices use electric or acoustic fields to change the properties of the medium, affecting the deflection based on polarization.

As used herein, the term “wavelength” is a measure of distance between two peaks (high points) or troughs (low points) in an electromagnetic wave, which is a repeating pattern of traveling energy such as light or sound.

As used herein, the term “directional optical element” refers to a component or structure used in optical systems to control the direction or propagation of light in a specific manner. A directional optical element is generally designed to manipulate the path, angle, and/or orientation of light beams, enabling precise control over their trajectory. Directional optical elements are integral to a variety of optical devices and systems, from simple lenses to complex photonic circuits. Types of directional optical elements may include lenses, lens arrays, mirrors, prisms, diffraction grating, waveguides, optical fibers, beam splitters, metasurfaces, resonant metasurfaces, and metalenses.

As used herein, the term “simulation” refers to a computer model of an object or physical phenomenon. A simulation can be used, for example, for the purpose of study or to develop and refine fabrication specifications. Various simulation methods can be used in the present system, device, and method, including but not limited to Finite Difference Time Domain (FDTD), ray tracing, Finite Element Analysis (FEA), and Finite Element Method (FEM). Use of simulation tools is important in the design of optical systems to achieve numerous performance outcomes, such as desired focal length, minimization of aberrations, optimization of manufacturability, and optimization of efficiency. In a simulation, one or more parameters of a light field display can include hogel pitch, a pixel pitch, and focal length. In another consideration, the angular field of view for a lens is defined by its focal length. Generally, a shorter focal length results in a wider field of view, where the focal length is measured from the rear principal plane of a lens. The rear principal plane of a lens is rarely located at the mechanical back of an imaging lens. Due to this, approximations and the mechanical design of a system are generally calculated using computer simulation.

As used herein, the term “circular polarization” refers to a state of polarization where the electric field of a propagating light wave rotates in a circular motion as it travels through space. In circular polarization, the electric field maintains a constant magnitude but changes its direction continuously in a helical pattern, creating a corkscrew-like effect along the direction of propagation. This rotation can occur either clockwise or counter-clockwise, leading to two distinct types of circular polarization: right-handed circular polarization (RHCP); and left-handed circular polarization (LHCP). The specific direction of rotation is determined by the orientation of the electric field as viewed from the perspective of the light source, relative to its propagation direction. Circular polarization has various applications in optical communications, imaging, and sensing technologies, due to its unique ability to maintain its polarization state even after reflecting or scattering from certain surfaces, as well as its compatibility with different types of optical components.

It is contemplated that any embodiment of the components, devices, articles, methods, and uses disclosed herein can be implemented by one skilled in the art, as is, or by making such variations or equivalents without departing from the scope of the invention. Various features of the invention will become apparent from the following detailed description taken together with the illustrations in the Figures. The design parameters, design method, construction, and use of the invention and structures disclosed herein are described with reference to various examples representing embodiments which are not intended to limit the scope of the invention as described and claimed herein. The skilled technician in the field to which the invention pertains will appreciate that there may be other variations, examples and embodiments of the invention not disclosed herein that may be practiced according to the teachings of the present disclosure without departing from the scope of the invention.

Described herein is an optical system and method of creating a time division multiplexing (TDM) light field display. The described TDM light field display uses light polarization components and techniques to produce high resolution pixel density in a light field for providing a multiplexed autostereoscopic multiple-view light field with high-angular resolution. Multiplexing of a light field display is a method of increasing the density of views (pixels) by shifting the light path or light field in or from a light source. The present time domain multiplexed light field display uses light polarization components and techniques to produce an ultra-high resolution pixel density using time domain multiplexing. The light field display is viewable with both horizontal and vertical parallax.

Multiplexing, in general, is a method of sending more than one signal over a link within a specific time frame. For a light field display, multiplexing refers to sending multiple images within the time frame that a single frame would be sent in a non-multiplexed display, in combination with some change in the optical system of the display for each multiplexed frame. A multiplexed light field display works by rapidly displaying multiple perspectives or images in quick succession to create the illusion of a three-dimensional scene. This technology leverages the principle of persistence of vision, where the human eye retains an image for a brief moment after it has disappeared. By sequentially projecting different viewpoints of a scene at high speeds, the display ensures that each eye perceives a slightly different image, corresponding to different angles of the same object. These images blend together due to the persistence of vision, resulting in a seamless and continuous 3D effect. Essentially, the display multiplexes various light fields over time, synchronizing them with the eye's natural retention of visual information, thereby creating an immersive and realistic visual experience without the need for additional devices like 3D glasses. A multiplexed image comprises two or more light field images, with each light field image projected to a different location. This is in contrast with a non multiplexed image or non multiplexed output which outputs or comprises only one projected light field image. Creating multiple images from the same source using multiplexing at a rapid frame rate effectively multiplies the image or pixel density of the light field by the number of images in each multiplexed image.

The concept of an observer-based function based on light in space and time, or plenoptic function, was developed to describe visual stimulation perceived by vision systems. The basic variables of the plenoptic function are dependent upon and include the three-dimensional (3D) coordinates (x, y, z) from which light is being viewed and the direction light approaches this viewing location, described by the angles (θ, ϕ). With wavelength of the light, A and time of the observation, t, this results in the plenoptic function:

P(x,y,z,θ,ϕ,λ,t)

Alternative to the plenoptic function, one may use radiance along light rays in 3D space at a point and given direction may be represented by a light field. The definition of the light field may be equivalent to that of the plenoptic function. A light field may be described as radiance flowing through all points in all possible directions, as a 5D function. For a static light field, the light field may be represented as a scalar function:

L(x,y,z,θ,ϕ)

where (x, y, z) represents the radiance as a function of location, and the light direction of travel is characterized by (θ, ϕ). A viewer of a 3D real world object is subject to infinite views, or a continuously distributed light field. To practically replicate this with a light field display, the present disclosure describes a light field display to subsample the continuously distributed light field into a finite number of views, or multiple views, to approximate the light field. The output of the direct projection light field display is a light field, which is a 3D representation of a continuously distributed light field based upon a finite number of views with angular resolution exceeding that of the human eye.

The view density of a light field display may be increased by reducing random polarization states of light using optical components thereby resulting in controllable polarized light emission. Polarized optical systems have enriched functionality beyond traditional refractive optics and are the cornerstone of many mature technologies, most notably the liquid crystal display (LCD) screen. Generally, optical design is dependent upon the wavelength and intensity of light and often neglects the polarization of the light.

To understand polarization, it is important to consider light as an electromagnetic wave, with the electric field of the wave oscillating perpendicularly to the direction of propagation or axis of travel of the light. Light is referred to as “unpolarized light” if the direction of this electric field is fluctuating randomly in time, or if the light has a random, time-varying polarization. Many common light sources produce unpolarized light, such as sunlight, halogen lighting, LED spotlights, and incandescent bulbs. If the direction of the electric field of light is well defined, it is referred to as “polarized light”. A laser is a commonly known source of polarized light.

A hogel is understood as a directional light emitting structure that emits light of varying color and intensity in different directions. Hogels generally consist of a plurality of sub-pixels. In one embodiment of a light field display, hogels may be shown with a plurality of RGB sub-pixels, however it is understood that hogels can comprise different combinations of number and color of sub-pixels. A three-dimensional (3D) light field display consists of an array of hogels, and an observer of the light field display will see a spot of light emitted from each hogel within the hogel array. The cumulation of spots of light from each of the hogels in the hogel array will create an image seen by the observer. A second observer positioned at a different location relative to the hogel array will also see spots of light from each hogel in the hogel array, but because they are observing the light field display from a different location, and therefore from a different direction, they will observe a different image than the first observer. For an n×m array of hogels, both observers will see an image produced by an n×m array of light spots. A hogel consists of a 2D pixel array (or sub-pixel array) and a directional optical element such as, for example, a lens or metasurface. Light emitted by each pixel or sub-pixel travels normal to the pixel array and the light emitted from each pixel or subpixel passes through the directional optical element and is directed in a predefined direction. A hogel with a p×q pixel or sub-pixel array will send light in p×q different directions. A light field display consists of a (n*p)×(m*q) pixel or (n*p)×(m*q)*3 sub-pixel array and an n×m array of directional optical elements, such that there are p×q pixels or sub-pixels per hogel in the n×m hogel array. The hogels are a product of combining the pixel or sub-pixel array with the array of directional optical elements. In a pixel array, each pixel consists of sub-pixels, with typically three adjacent RGB sub-pixels forming a pixel.

The collection of pixels and subpixels which comprise each hogel can be generated by a variety of light sources including, but not limited to, Light Emitting Diodes (LEDs), projector devices, Organic Light Emitting Diodes (OLEDs), and electroluminescent (EL) devices. In one embodiment, to achieve the desired pixel density for a high-resolution light field display comprising the presently disclosed optical system, light is preferably generated by an OLED array, more specifically, a microcavity OLED MCOLED array. A pixel, as is generally understood in the art, broadcasts light in many directions. Each pixel consists of one or more pixel driver circuits and one or more subpixels, which can be red, green, or blue (RGB) subpixels. A plurality of pixels, propagating light in a plurality of directions, forms a pixel array. A pixel driver circuit controls the subpixel and drives different voltages to the light emitting devices to achieve different colors and intensities. In an array of subpixels, an array of pixel driver circuits operatively connected to each subpixel sits behind each subpixel in the array.

As per the present disclosure, each subpixel may be comprised of a microcavity organic light emitting diode (MCOLED). A MCOLED is a device in which the materials of an OLED are bound in a microcavity defined by two reflective surfaces arranged in such a way to reflect light within a specific range, or some combination of dielectric and metallic materials. The organic materials which make up the OLED stack are arranged with material thicknesses dⱼ which have an optical path length of Lⱼ, where Lⱼ=nⱼ×dⱼ, and where nⱼ is the refractive index of the OLED material. The sum of the optical path length of the materials between the reflective surfaces is designed to equal

$$\frac{m {λ}_{i}}{2} ,$$

where λᵢ is the peak design wavelength of the MCOLED. The optical path length can therefore be changed by changing the thickness of one or more of the materials between the reflective surfaces, or by adding one or more additional filler material. The use of a microcavity in an OLED structure decreases the spectral width of the OLED, decreases the angular output, and increases the overall efficiency. Tuning of the optical microcavity for specific wavelengths of light, or color, is generally achieved by creating a resonance at a specific wavelength between two reflective surfaces, completed by selecting and defining material thickness, refractive index, and phase change through careful analysis and simulations.

Multiplexing of a light field display is a method of increasing the density of views, or density of pixels, by shifting the light path or light field in or from the original path of the light source. Temporal multiplexing, or time division multiplexing, in some embodiments, refers to the use of some means of interleaving narrow-band or slow-speed data from multiple sources to make use of a wide-band or high-speed transmission resource or channel. Depending on whether a master system clock is used or not, multiplexing is either synchronous or asynchronous. Two common means of multiplexing are time division multiplexing (TDM) and frequency division multiplexing (FDM). TDM interleaves data from different or separate sources in time, whereas the latter does so in frequency. The presently described light field display can incorporate time division multiplexing techniques with a mechanism to recover discarded light due to polarization to increase the overall light field display system efficiency, thereby lowering the burden on the OLED device(s).

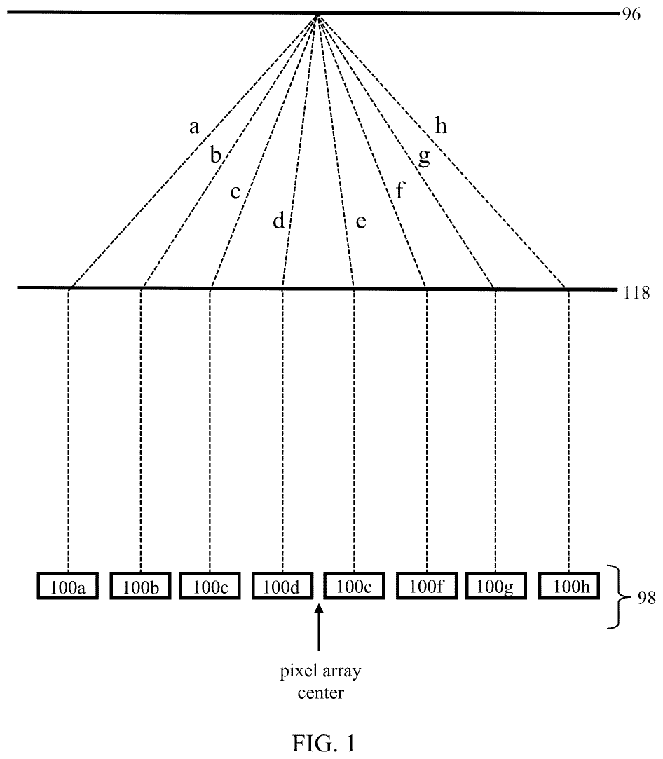

FIG. 1 illustrates a cross-section of the ray path of individual pixels of a pixel array 98 with an associated directional optical element 118. The directional optical element 118 receives light from the pixels 100a-h in the pixel array 98 and changes the angle of light propagation toward focal plane 96. The directional optical element 118 may comprise, for example, a lens or plurality of lenses, metalens, diffraction grating, waveguides, optical fibers, or a metasurface, such as an engineered metasurface. The array of pixels 100a, 100b, 100c, 100d, 100e, 100f, 100g, 100h in the pixel array 98 is modeled as regularly spaced point sources with pixel pitch σ, and where the array of pixels or point source positions along the x-axis in the pixel array is given by:

$$x = \{ - 7 σ / 2 , - 5 σ / 2 , - 3 σ / 2 , - σ / 2 , σ / 2 , 3 σ / 2 , 5 σ / 2 , 7 σ / 2 \} .$$

The ray paths of the chief rays of each of pixels 100a-h, which serve as point sources of light, are traced and then deflected by a linearly spaced set of angles according to the following:

$$\{ a , b , c , d , e , f , g , h \} = \{ - 7 Φ / 2 , - 5 Φ / 2 , - 3 Φ / 2 , - Φ / 2 , Φ / 2 , 3 Φ / 2 , 5 Φ / 2 , 7 Φ / 2 \} .$$

The predefined direction associated with each subpixel is determined by its geometrical location within the pixel plane as each position within a lens' focal plane corresponds to a unique direction or angle of light emission at directional optical element 118. A positional array of point sources at the focal length of a lens or directional optical element will correspond to a directional array of light beams a-h originating from pixels 100a-h being emitted from the directional optical element 118 to the focal plane 96, where the angle of light emission is dependent on the interaction of the light beam from each pixel with the directional optical element 118. For example, for an ideal f-theta lens or a f-tan-theta lens, a regularly spaced pixel array with a constant pixel pitch, σ, will result in a regularly spaced directional array with a constant angular pitch, Φ. The angular pitch of a light field display refers to the angular separation between individual light rays or views as they are emitted or projected from the display surface. The angular pitch quantifies the level of angular resolution in the display, indicating how finely it can represent different directions in space. In a light field display, each point on the display emits light rays at various angles, creating the perception of a three-dimensional scene with depth and parallax. Angular pitch is an important parameter because it determines the degree of smoothness and accuracy in representing the light field's angular information. A smaller angular pitch, which has a tighter angular spacing, generally indicates higher angular resolution, allowing for smoother transitions between different viewing angles and a more realistic representation of 3D content. This translates to improved image quality and a more convincing 3D effect at greater depths in and out of the display. A larger angular pitch, on the other hand, indicates greater angular separation between emitted rays, which may lead to a more noticeable discontinuity or reduced quality in representing angular variations. The pixel array is preferably connected to a thin film transistor AMOLED backplane. As observed, the pixels that are closer to the center of the pixel array or hogel are deflected less than pixels that are near the edge or outside of the hogel, therefore if the apparent pixel position is farther from the center of the pixel array or hogel then it will be deflected more than beams originating from apparent pixels closer to the center of the hogel. Pixels 100d, 100e in pixel array 98 are considered closest to the center of the hogel.

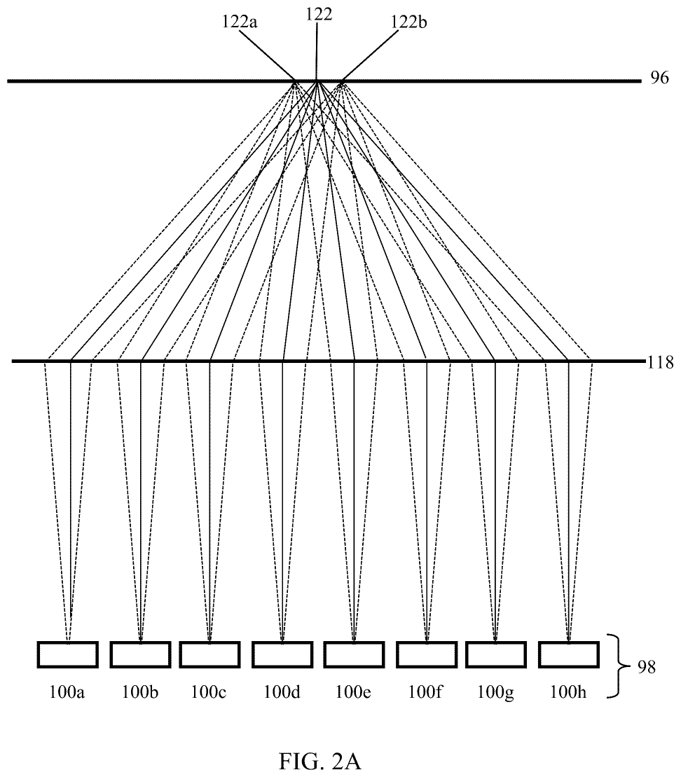

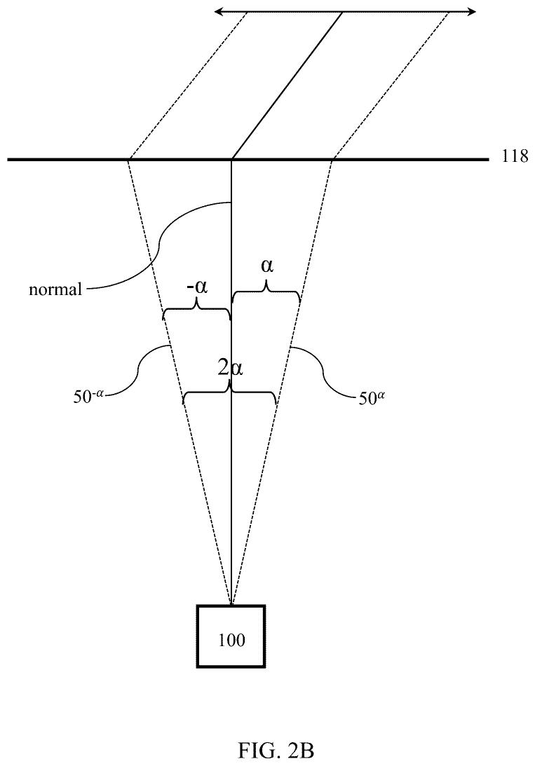

FIG. 2A illustrates a cross-section of the ray path of individual pixels of a 2D pixel array 98 with directional optical element 118 and an associated focal plane 96, illustrating three ray paths per pixel. The pixel array 98 is modeled by an array of pixels 100a, 100b, 100c, 100d, 100e, 100f, 100g, 100h, which are point sources regularly spaced at a pixel pitch. As shown, three rays are traced per pixel: one normal to the directional optical element 118 shown as a solid line; and two rays at angles of −α and α from normal shown as dashed lines. The rays at angles −α and α relative to normal are illustrated to show the full width at half maximum (FWHM) of light originating from each pixel. Depending on the emission angle of the light ray from each pixel, the light ray will intersect focal plane 96 at a different location. The ray path of each of the rays traced per pixel 100a-h is altered at the directional optical element 118 and each ray is then directed by the directional optical element 118 to a focal point on the focal plane 96. Rays from the same pixel are parallel when leaving the directional optical element, and thus intersect in different locations on the focal plane 96. The focal point of the rays depends on the emission angle of the light relative to the pixel plane at pixel array 98. When the emission angle for each ray is normal to the directional optical element and the pixel plane, the light rays will be received at focal point 122. Focal point 122a is shown for the rays emitted at an angle of −α from each pixel, and focal point 122b is shown for the rays emitted at an angle of α from each pixel. The focal point may vary depending on the properties of the directional optical element 118.

FIG. 2B illustrates a ray path diagram of a single pixel 100 in a pixel array with a directional optical element. The angle 2α is the angular Full-Width at Half Maximum (FWHM) of the point light source or pixel 100, with spread at an angle of −α to α from normal. The angular spread out of the pixel is collimated and redirected by a directional optical element 118. Light beams 50^{-α} and 50^{α} represent the FWHM beam spread from pixel 100, with multiple other light beams in between as emitted from pixel 100.

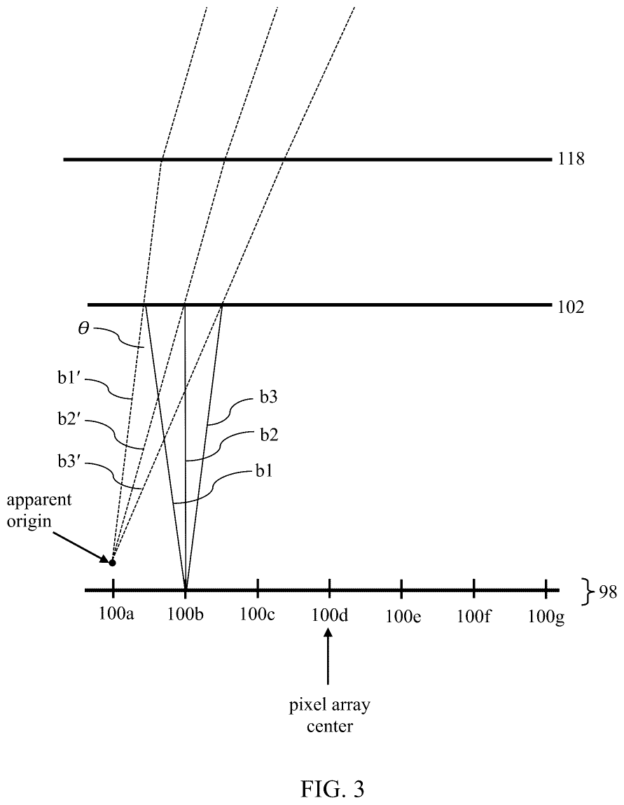

FIG. 3 illustrates a cross-section of the ray path of an individual pixel in a pixel array 98, comprising pixels 100a, 100b, 100c, 100d, 100e, 100f, 100g. Beam deflector 102 is shown as an ideal beam deflector that acts as a directional optical element to change the transmission angle of the light beam. A beam deflector is an optical device that alters the direction of a light beam, typically using reflection, refraction, or diffraction. Common beam deflectors include mirrors, prisms, blazed gratings, and diffraction gratings. Forward ray tracing rays b1, b2, b3 emitted from pixel 100b toward beam deflector 102 are shown together with backward ray tracing rays b1′, b2′, b3′ to a single point at an apparent origin above the pixel array 98. The apparent origin is at a location near the pixel array where the light rays appear to originate from based on the applied altered light beam direction imposed by the beam deflector 102. In this embodiment an ideal beam deflection optical element or beam deflector 102 is placed between the pixel array 98 and directional optical element 118 to direct light emitted from pixel 100b. The beam deflector 102 is a planar structure that is parallel to the pixel array 98 and directional optical element 118. Rays of light b1, b2, b3 transmitted through the beam deflector 102 are bent by a fixed angle, θ. As shown, rays traced backward b1′, b2′, b3′ from the intersection point(s) of forward traced rays b1, b2, b3 with the beam deflector 102 intersect at a single point above the pixel array at an apparent origin, illustrating the effect of fixed angle, θ on the apparent origin of the rays. As the image of the pixel, which is located at the intersection point, is above the plane of the pixel array 98, its rays are no longer collimated by directional optical element 118, which provides unfocused light exiting the directional optical element 118.

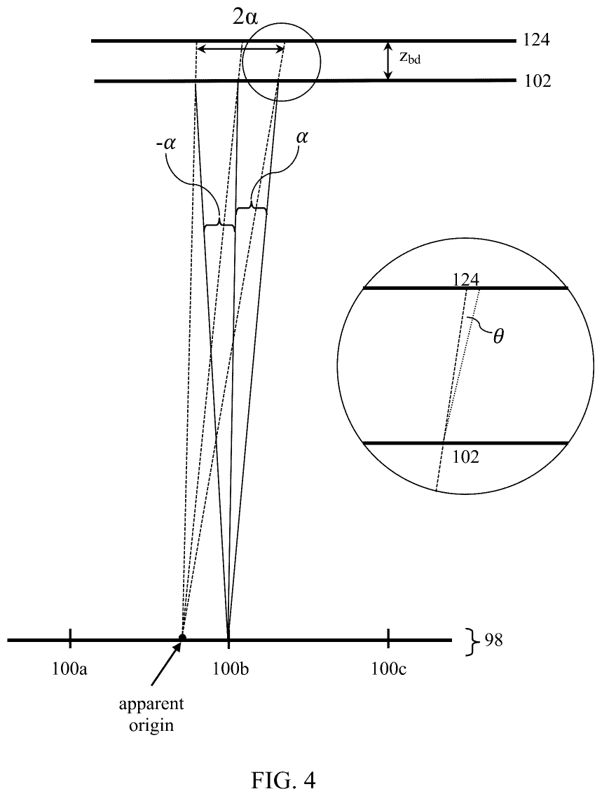

FIG. 4 illustrates a cross-section of the ray path of light from an individual pixel 100b in a pixel array 98 comprising a plurality of pixels 100a, 100b, 100c. Forward and backward tracing of the ray path to and from a plane parallel to the pixel array through a beam deflector is shown. Pixel 100b is shown as a representative pixel, with an associated reference plane 124 and a beam deflector 102, spaced from the reference plane 124. In this embodiment, an ideal beam deflection optical element or beam deflector 102 is placed between the pixel array 98 and reference plane 124. As used herein, reference plane 124 is an imaginary plane used as a point of orientation to illustrate the spatial relationship between ray paths of individual pixels and is not a physical component of the disclosed optical system. Rays of light transmitted through the beam deflector 102 are bent by the beam deflector 102 at a fixed small angle, θ, independent of the angle of incidence. Rays of light emitted from an in-focus point source array that pass through a beam deflector 102 will then be directed by a lens or lens-like element at reference plane 124 according to its apparent origin which is shifted from the actual origin of the light rays at pixel 100b. Specifically, an apparent origin is the location of intersection of a reverse ray tracing of the emitted light traveling through the beam deflector originating at the intersection point(s) of each light ray which has been deflected by the small fixed angle θ. For the apparent origin shown, the beam deflector has shifted the light rays such that the light image appears to originate from a location shifted to the left of the pixel 100b. The apparent origin can also be referred to as a virtual pixel, where the term “virtual pixel” denotes the location of the apparent origin of a pixel when a beam deflector acts on the originating light to change the apparent location of the light source. In time division multiplexing, a time division multiplexing system is capable of controllably deflecting light rays emitted from a pixel to effect an apparent pixel origin which is not at the actual pixel location in the pixel array.

In the embodiment shown in FIG. 4, beam deflector 102 is located a distance z_{bd} below the reference plane 124 and positioned above the pixel array 98. Three light rays emitted from pixel 100b are shown as solid lines traced from pixel 100b toward beam deflector 102, with the central ray normal to the reference plane 124 and two rays at angles of −α and α from normal. The angle 2α is the angular full width half maximum (FWHM) of the source pixel, and the FWHM angle is retained subsequent to beam deflection. The apparent origin of the rays can be extrapolated back to pixel 100b in the source plane at the pixel array 98 and can be expressed as:

$${x}_{0}^{′} = {z}_{b d} tan ( - θ )$$

$$( {x}_{\pm }^{′} ) = {z}_{b d} ( tan ( \pm α ) - tan ( \pm α + θ )$$

Differences in the apparent position of these three rays which trace back to an apparent origin blurs the angular output, effectively moving the pixel out of focus, which is consistent with the three backward extrapolated rays converging above the reference plane 124. The rays transmitted by a lens or directional optical element at reference plane 124 are not well collimated in comparison to the angular pitch. For sources with small angular divergence, such as for example a MCOLED, and for small deflection angles, such that |α|+|θ|<10°, the small angle approximation can be applied, which results in x₀′=x₊′=x₋′=−z_{bd} θ. In this instance it is evident that the three backward extrapolated light rays effectively converge at the pixel plane 98.

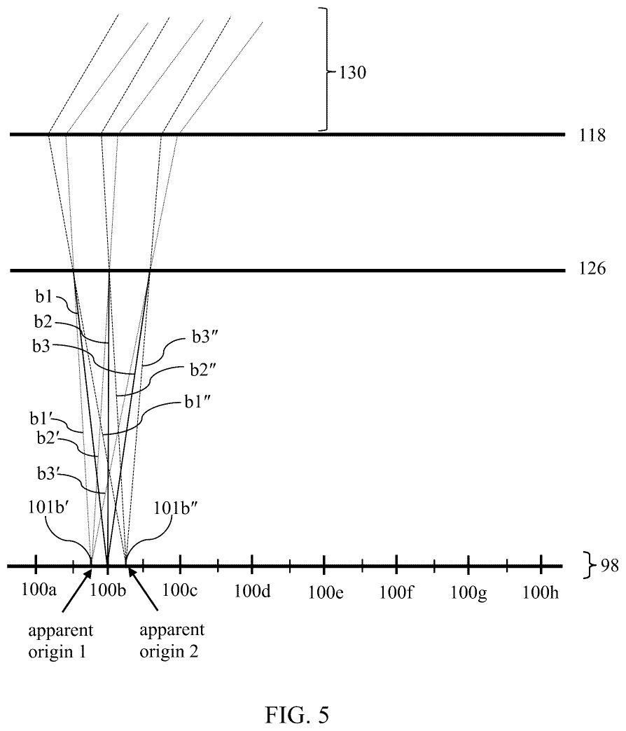

FIG. 5 illustrates a cross-section of the ray path of a single pixel 100b in a pixel array 98 in a time division multiplexing system 126 and transmitted to a directional optical element 118. In an embodiment wherein the beam deflector is switchable such that it can deflect light rays at an angle of ±0, the apparent source of the light can be shifted from pixel 100b in the pixel array 98 to virtual pixel 100b′ adjacent pixel 100b in the same plane as the pixel array 98. The design of the time division multiplexing system 126 is such that the deflection angle positions the apparent pixel position at +1/4 or −1/4 of the pixel pitch relative to the actual pixel in the pixel array 98. If

$${z}_{b d} = \frac{σ}{4 θ} ,$$

then the apparent point source position of rays traced from pixel 100b in pixel array 98 can thereby be shifted by ±σ/4. In this way, the pixel pitch between adjacent virtual pixels at each of the apparent origins remains consistent in a TDM system, specifically at a distance of half the pixel pitch of the pixels in the pixel array 98. Considering a pixel array 98 of a plurality of point sources regularly spaced with pixel pitch α, the array of point source positions is given by {0, σ, 2σ, 3σ, . . . }. With the shift enacted by the beam deflector, the array of apparent source positions can become:

$$\{ - σ / 4 , σ / 4 , 3 σ / 4 , 5 σ / 4 , 7 σ / 4 , 9 σ / 4 , 11 σ / 4 , 13 σ / 4 , … \} .$$

With the shifting, the effective pixel pitch and resulting angular pitch can be effectively halved. Light emitted by the time division multiplexing system 126 is directed to a directional optical element 118. A directional optical element 118 manipulates the path or propagation direction of a light ray, altering its trajectory through reflection, refraction, diffraction, or other optical phenomena, to achieve a specific purpose such as steering a light ray, resulting in a directional light ray 130. The presently described TDM can display a light field comprised of a plurality of hogels.

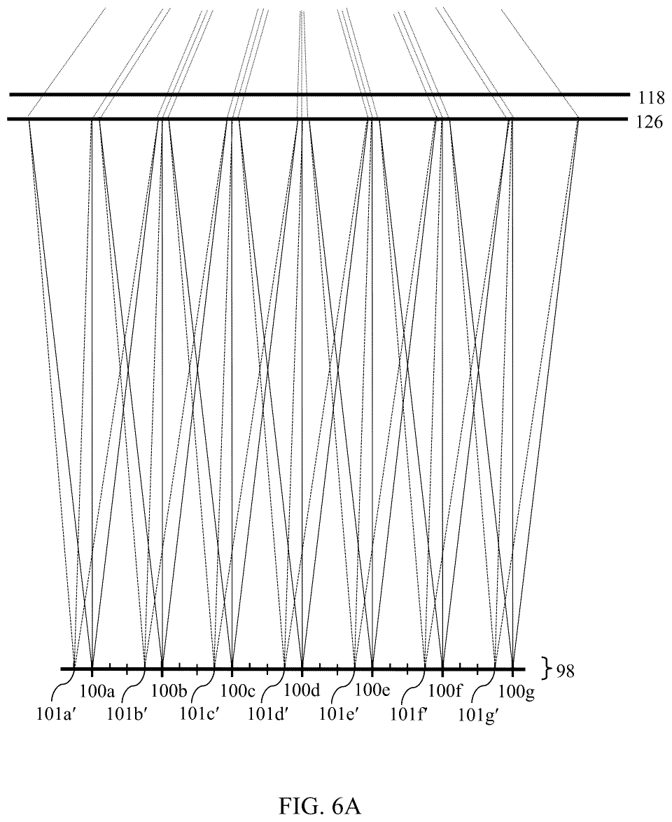

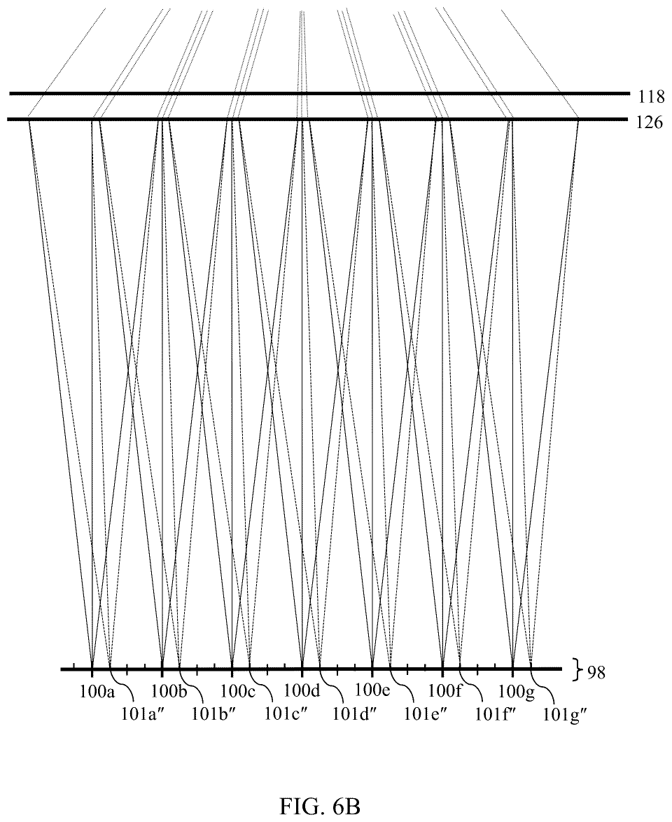

FIG. 6A illustrates a cross-section of the ray paths for light emitted from individual pixels in a pixel array through a time domain multiplexing system 126 where the apparent origin of each pixel is shifted to the left relative to the actual location of each pixel in the pixel array. Pixel array 98 comprises pixels 100a-100g and light from the pixel array is emitted in the direction of an interstitially placed time division multiplexing system 126, followed by direction optical element 118. The time division multiplexing system 126 shifts the direction of each light ray based on the time domain state of the time division multiplexing system 126. Virtual pixels 101a′-101g′ at the apparent origins of pixels 100a-100g are shifted at a distance of 1/4 pixel pitch to the left of the location of pixels 100a-100g in the pixel array 98. Though the discussion thus far has been confined to a cross section of a pixel array, it is understood that the same description can be easily expanded to a 2D planar array of pixels located at pixel array 98, or to a hogel array as is commonly found in holographic and light field displays.

A hogel, within the context of light field or holographic displays, is a basic unit or element that emits a bundle of light rays with varying directions, intensity, and phases. Unlike conventional pixels, which emit light in a uniform direction, a hogel is designed to project light in multiple directions, effectively creating a small region of a 3D holographic image. The emitted light rays from a hogel carry information that determines the angle at which light is projected, allowing the holographic display to create a perception of depth and parallax when viewed from different positions. By manipulating the orientation and intensity of the directional light rays emitted from a plurality of pixels, a hogel can simulate a segment of a 3D scene. When a grid of hogels works together, the resulting combination of directional light rays reconstructs a complete light field, or holographic image, with rich spatial information, enabling viewers to perceive different aspects of the scene as they change their perspective. Thus, a hogel serves as a foundational building block in creating complex light field displays and visualizations.

FIG. 6B illustrates a cross-section of the ray paths for light emitted from individual pixels in a pixel array through a time domain multiplexing system 126 where the apparent origin of each pixel is shifted to the right relative to the actual location of each pixel in the pixel array. Pixel array 98 comprises pixels 100a-100g and light from the pixel array is emitted in the direction of an interstitially placed time division multiplexing system 126 and directional optical element 118. The time division multiplexing system 126 shifts the direction of each light ray based on the time domain state of the time division multiplexing system 126. Virtual pixels 101a″-101g″ at the apparent origins of pixels 100a-100g are shown shifted at a distance of 1/4 pixel pitch to the right of the location of pixels 100a-100g in the pixel array 98. With control of the direction of each ray based on an imposed circular polarization of the light ray, the time division multiplexing system 126 can thereby achieve two different apparent pixel locations, thereby effectively doubling the number of pixels without changing the structure of the pixel array 98.

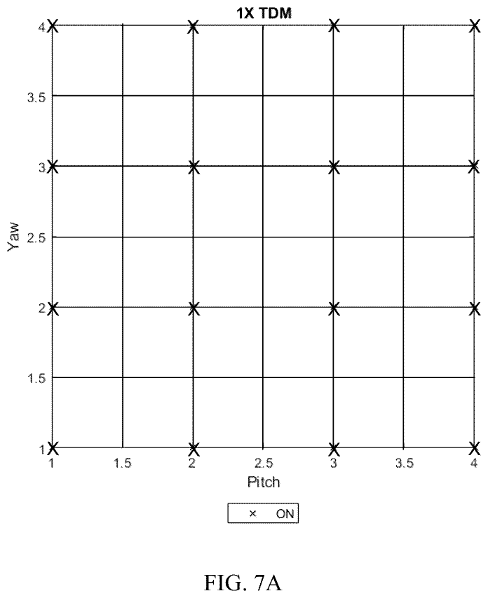

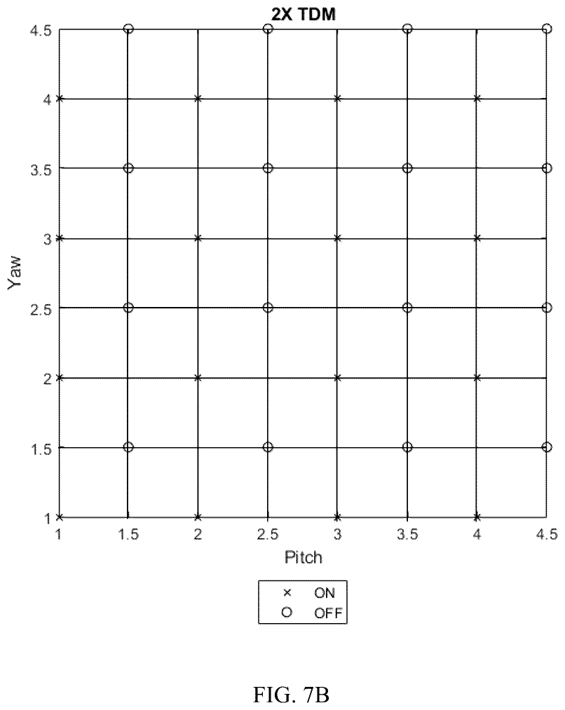

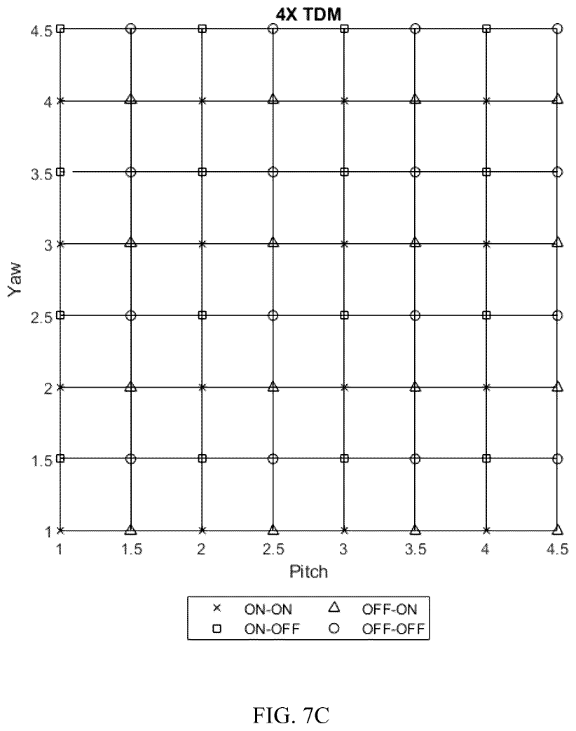

FIG. 7A illustrates a map of an ideal directional array for a 1×TDM display, which is equivalent to a system without a TDM scheme. This idealized directional array map is representative of light travel from each pixel in a pixel array to create a light field where the apparent origin of the light is in the same location as each pixel, or is at a consistent offset for each pixel. The notation X indicates the illumination of light from each pixel in the 2D pixel array in the resulting light field or display.

FIG. 7B illustrates a map of an ideal directional array for a 2×TDM display with a 2×TDM scheme, wherein the effective pixel density is increased by a factor of 2. The notation X indicates the illumination of light from each virtual pixel in the 2D pixel array in the resulting light field in the first time domain state T1 and the notation O indicates the illumination of light from each virtual pixel in the 2D pixel array resulting from light field in the second time domain state T2. As shown, using a time division multiplexing system, multiple images can be produced at different locations, providing a multiplexed, multiple view, light field display. In this case shown, the same pixel array can generate double the number of images, or two images per pixel, by shifting the light beam between two locations in the produced light field. To create a 2×TDM each pixel in the pixel array has two unique apparent positions, a first virtual position and a second virtual position, each of the virtual positions at a ¼ pixel pitch in each dimension from the actual position of the emitting pixel. This effectively doubling the pixel density using beam deflection.

FIG. 7C illustrates a map of an ideal directional array for a 4×TDM display. Multiple beam deflectors can also be stacked on top of each other to further increase pixel density. Consider a pair of beam deflectors where the first beam deflector is designed to shift the apparent pixel position [x, y] by either [σ/4,0] or [σ/4,0] and where the second beam deflector is designed to shift the apparent pixel position [x, y] by either [0, −σ/4] or [0, σ/4]. The illustrated 4×TDM system provides, for each pixel, four unique apparent pixel positions (X, O, Δ, □) corresponding to four unique directions. The effective pixel density of the 4×TDM system is double that of the 2× system and quadruple that of the 1× system.

The discussion above focuses on point sources for illustrative purposes. Practically, however, pixels have a finite size. In geometric optics collimated light entering a lens will come to a point at the focal plane of the lens. The location of the focal point within the focal plane is determined by the direction that the collimated light enters the lens. In particular, there is a one-to-one correspondence between positions in the focal plane and directions into the lens. A hogel illustrates the same behavior but in reverse. In a hogel, light originates from a pixel within the focal plane of the lens and the position of that pixel within the focal plane determines the direction that light exits the display lens. As pixels are non-point objects with finite size, they will emit light over a range of directions corresponding to the area each pixel occupies in the focal plane of a lens. The angular spread of light between the pixel point source or apparent origin is required for reconstructing a wavefront for a light field, as, if the output light beam emitted by each pixel are perfectly collimated, the solid viewing angle in the viewing zone would not be filled with light, requiring viewers to be at fixed directions or in fixed locations to receive a quality light field for viewing. Alternatively, too much angular spread is also undesirable as this causes the output of adjacent pixels to blur indistinguishably, thereby reducing the achievable depth of field of the light field display.

Depth of field for a light field display refers to the range of distances within a scene where objects appear in focus to the viewer. In light field displays, which capture and reproduce the directional information of light rays in addition to their intensity, the concept of depth of field plays a crucial role in creating a realistic 3D visual experience. A light field display projects light rays from various angles, allowing viewers to perceive different perspectives based on their position relative to the display. This creates a sense of depth and parallax, enabling the viewer to experience a 3D scene without special glasses. Depth of field in this context relates to the depth range over which the reproduced 3D scene maintains visual clarity or sharpness. Objects within this range appear crisp and in focus, while those outside this range may appear blurred or out of focus. This effect occurs due to the nature of light field displays, which can simulate optical depth cues by adjusting how light rays are directed and combined. A light field display with a broader depth of field can render more of the scene in focus, offering a greater sense of realism and flexibility in viewing positions. Conversely, a narrower depth of field can create a more selective focus effect, emphasizing certain areas of the scene while blurring others, similar to a traditional camera lens with a shallow depth of field. Overall, depth of field in light field displays is a key parameter influencing the visual experience and contributes to the illusion of depth in the projected 3D scene.

As there are multiple sources of angular spread within the system, such as chromaticity within the bandwidth of a single-color channel, the angular spread due to the finite size of a subpixel must be less than twice the angular pitch. The angular pitch of a light field display refers to the angular separation between individual light rays or views as they are emitted or projected from the display surface. The angular pitch quantifies the level of angular resolution in the display, indicating how finely it can represent different directions in space. Given that there is a one-to-one mapping between positions within the focal plane and angles in directional space, the angular pitch is set by the pixel pitch. Directional space refers to a conceptual framework in which the directions of light rays are mapped or analyzed. In optical and imaging contexts, the term “directional space” is often used to describe the range of angles at which light rays can propagate from a given point or through a system. Directional space is especially relevant in light field displays, holography, and other advanced optical systems that deal with the directional characteristics of light. In a light field display, for instance, each pixel or emitting point projects light rays into the surrounding space at different angles. Directional space represents this range of angles and can be used to understand and manipulate the behavior of light in these systems. Directional space also allows for the analysis of how light interacts with objects, propagates through media, or is perceived by an observer. The angular spread due to the finite size of a pixel cannot go beyond one angular pitch when TDM is not applied. For TDM systems the effective pixel density increases by a factor of 2 and 4 for a 2× and 4×TDM systems, respectively, therefore, to maximize the depth of field of the display the pixel size must be reduced relative to the hogel to limit the angular spread. By reducing the range of angles from which light rays from subpixels are emitted from a hogel (i.e., a narrower field of view), the resulting light field images tend to have a greater depth of field because a narrower angular spread reduces blurring of the output of neighbouring pixels so that the angular resolution of the hogel is fully utilized.

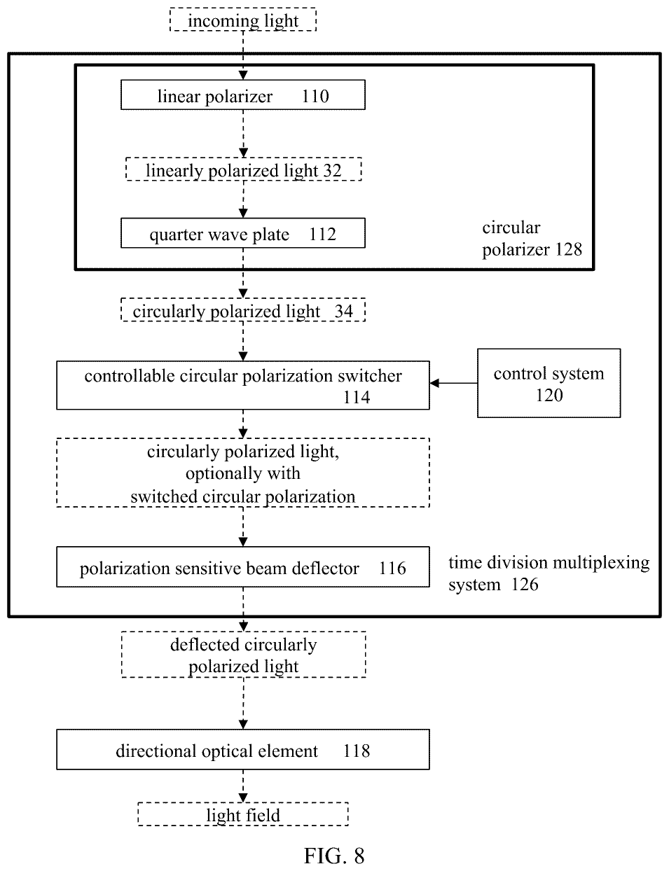

FIG. 8 illustrates components of a time division multiplexing system 126 and the transformation of the light by each component. The time division multiplexing system, which may be comprised of a polarization sensitive optical system and a polarization beam deflector, is capable of manipulating the emission direction of a light beam in a light field by utilizing the components in the time division multiplexing system 126 to shift the ray path of light emitted from the light source, i.e. incoming light, such that the output beam can be propagated to at least two different angles to provide a multiplexed light field display. To achieve this switching, a set of light manipulation optical devices, together referred to as the time division multiplexing system 126, is placed in the light path to change the polarization and thereby the output angle of the light making up the light field display. In an embodiment, a time division multiplexing time division multiplexing system 126 device comprises a polarization sensitive optical system further comprising, in series, a circular polarizer 128 comprising a quarter wave plate 112 and optionally a linear polarizer 110, a circular polarization switcher 114 connected to a control system 120, and a polarization sensitive beam deflector 116. Together with directional optical element 118, a time domain multiplexed light field can be generated, offering increased pixel density of the light field with no structural change in the light emission hardware. In the case where the incoming light is already linearly polarized, the circular polarizer 128 does not need to comprise a linear polarizer 110. The phase and nature of the light in the system is shown in dashed boxes. Generally, a time division multiplexing system for a light field display as presently described receives light from a source that generates a light beam and transforms the light into a directional circularly polarized beam which can be deflected based on its polarization at a polarization sensitive beam deflector 116. The present system can transform multiple incoming light beams into multiple directional circularly polarized beams and can thereby create a multiple-view, autostereoscopic, high-angular resolution, multiplexed light field display.

The incoming light can come from, for example, one or more Light Emitting Diode (LED), projector device, Organic Light Emitting Diode (OLED), and electroluminescent (EL) device. In a specific example, the light source can be a 2D pixel array comprising individual pixels, separated by a pixel pitch. The source light or incoming light to the time division multiplexing device can be polarized, or not polarized. Some light sources that emit linearly polarized light include but are not limited to some OLED devices, quantum dots, Gallium nitride (GaN) micro-LEDs. If the incoming light is not already polarized then the system will comprise an optional linear polarizer 110 to polarize the light. When light is linearly polarized, the electric field oscillates in a single, consistent plane as it travels. In optical devices and instruments, linear polarization is used to control the propagation of light. A linear polarizer is an optical device designed to filter light so that only waves oscillating in a specific plane are transmitted, while other waves with perpendicular polarizations are blocked or absorbed. In its most basic form, a linear polarizer contains a material with a specific structure or alignment that selectively transmits light with a particular polarization direction. Common mechanisms by which linear polarizers work include polaroid polarizers, which utilize elongated molecules to absorb light oscillating in one direction while transmitting light in the perpendicular direction; wire-grid polarizers, where closely spaced parallel wires or conductive strips block light with electric fields parallel to the wires while allowing perpendicular light to pass through, and birefringent polarizers, which exploit materials with different refractive indices based on polarization to split light into ordinary and extraordinary rays. When light encounters a linear polarizer, only the component of the electric field that aligns with the polarizer's transmission axis passes through, effectively filtering the light. By controlling the plane of polarization, linear polarizers play a crucial role in various technological and optical applications. Preferably, the linear polarizer transmits one of p-polarized light or s-polarized light and transforms any non-transmitted p-polarized light into s-polarized light, and vice versa. There are various types of linear polarizers, including absorptive polarizers and beam-splitting polarizers, for specific examples including linear polarizing films, and laminates that can be made from a variety of materials, including polymers and glasses.

A quarter wave plate 112 receives linearly polarized light 32 from the linear polarizer 110, or alternatively from a linearly polarized light source, and transforms the linearly polarized light 32 into circularly polarized light 34. The linear polarizer 110 in combination with the quarter wave plate 112 form a circular polarizer 128. The resulting circularly polarized light can be either RHCPL or LHCPL. It is noted that the circular polarizer 128 may also be comprised of a linear polarizer 110 and a zero order wave plate. A controllable circular polarization switcher 114 can then be used to optionally rotate the handedness of the circularly polarized light. The controllable circular polarization switcher 114 acts as a switchable optical component that can be controlled by control system 120 to either change the polarization and the directionality of an incoming light beam. In a first condition the circular polarization switcher 114 will reverse the handedness of the circularly polarized light, and in a second condition the circular polarization switcher 114 will retain the same rotational handedness as the handedness of the beam that entered the circular polarization switcher 114. The direction or angle of the light beam emitted from the directional optical element 118 of the time domain multiplexing system depends on the handedness of the beam leaving the circular polarization switcher 114. As such, the circular polarization switcher 114 acts to multiplex the emitted light beam by changing the handedness of the light beam to enable angular redirection of the light beam at the polarization sensitive beam deflector 116.

The circular polarization switcher 114 is controlled by a control system 120 to control the switchable nature of the circular polarization switcher 114 to alternate or control the handedness of the emitted circularly polarized light. This can be done at a regular frequency in order to multiplex the light originating at the light source. Preferably, the frequency of the polarization switching is faster than is perceptible to the human eye, or faster than about 30 Hz. In one example, the circular polarization switcher 114 can be a switchable half wave plate component connected to a current source configured to receive the circularly polarized light beam of a first handedness and generate a circularly polarized light beam of a second handedness. In one specific example, when the current source to an electrically switchable half wave plate is an off state the resulting light beam has the opposite circular polarization as the incoming beam, and when the current source is an on state it transmits a circularly polarized light beam of the same handedness as the incoming beam. In a particular example the circular polarization switcher 114 can be, for example, a switchable liquid crystal half wave plate (SLC-HWP).

The polarization sensitive beam deflector 116 is configured to receive circularly polarized light, optionally with switched circular polarization, from the circular polarization switcher 114. Generally, the polarization sensitive beam deflector 116 is a Pancharatnam-Berry beam deflector (PBBD), such that circularly polarized light that is circularly polarized of a first handedness will be deflected by a first deflection angle in a first direction, and circularly polarized light that is polarized of a second handedness and deflect it by a second deflection angle in a second direction, opposite to the first direction. To do this, the beam deflector imparts a geometric phase modification on the circularly polarized light beam of the first handedness or the circularly polarized light beam of the second handedness to produce a light wave. Preferably, the light wave consists of a zero order and a diffracted order. In this way, the polarization sensitive beam deflector 116 can receive LHCPL and send it in a first direction, and receive RHCPL sending it in a different second direction.

A Pancharatnam-Berry beam deflector (PBBD) is a metasurface consisting of a 2D array of subwavelength Pancharatnam-Berry Optical Elements (PBOE), which are half waveplates (HWP) that are oriented to impart a specific phase onto circularly polarized light. By controlling the orientation of the PBOE, the Pancharatnam-Berry metasurface acts as a phase mask. In one embodiment, a PBBD is a Pancharatnam-Berry metasurface where the phase increases linearly. The deflection angle imparted by the PBBD is proportional to the phase gradient as stated in the generalized Snell's law:

$${n}_{t} sin {θ}_{t} - {n}_{i} sin {θ}_{i} = {k}_{o} \frac{- d ∅}{d x} .$$

Considering nᵢ=nₜ and that the desired beam deflector angle is very small (less than a degree), for small incidence angles, θᵢ, the PBBD will deflect rays by a fixed angle as transmission angle, θₜ, will scale linearly with θᵢ. A PBOE will impart the opposite phase to right and left circularly polarized light, therefore, right and left circularly polarized light will experience opposite phase gradients and will be deflected in opposite directions.

The directional optical element 118 is configured to receive the circularly polarized light beam in the first direction and second direction from the polarization sensitive beam deflector 116 to generate a light field. The directional optical element is insensitive to the polarization of light. The directional optical element 118 may comprise any suitable display optical component including, but not limited to, a single lens, a lens array, a pinhole array, a metasurface, an engineered metasurface, or a metalens.

In the case of the presently disclosed light field display, in a 2×TDM system, the separate sources providing data to be interleaved are in fact different states of the light field display. The first state of the light field display is herein referred to as the T1 (OFF) state wherein the circular polarization switcher 114 switches the circular handedness of the incoming circularly polarized light beam, and the T2 (ON) state wherein the circular polarization switcher 114 retains the circular handedness of the incoming circularly polarized light beam. In a switchable liquid crystal half wave plate (SLC-HWP) the control system 120 enables current to flow in the T2 state, aligning the crystals in the crystal cell and allowing the circularly polarized light to pass through unchanged. When no current is applied in the T1 state, the handedness of the circularly polarized light is switched. The polarization of the light emitted by the optical system and thereby the direction of the beam leaving the directional optical element 118 is dictated by the light field display state. The polarization manipulation of light from the pixel light source, through each component of the disclosed optical system is described in greater detail by the following figures.

FIG. 9 illustrates light polarization transformation of light rays through an example time division optical multiplexing system in the T1 state. The system as shown results in a light beam emitted in the T1 state as will be further described later. When the incoming light is from a non-polarized light source, light is transmitted through the linear polarizer 110 to provide linearly polarized light 104, which then travels through the quarter wave plate 112. In the shown embodiment, light is received to a linear polarizer 110 which converts the incoming light into linearly polarized light 104. In the case where the incoming light is already linearly polarized this component is not required. In the embodiment shown, a quarter wave plate 112 downstream from a linear polarizer 110 forms a circular polarizer 128. The quarter wave plate 112 receives the linearly polarized light beam 104 and transforms the polarized light beam into a circularly polarized light beam of a first handedness, either right-handed circularly polarized or left-handed circularly polarized light. In this example, light leaving the quarter wave plate 112 is left-handed circularly polarized light (LHCPL) 74. The quarter wave plate 112 is designed to alter the polarization state of light waves from linear to circular by introducing a specific phase shift between two orthogonal components of the light. A quarter wave plate is typically made from birefringent material, which has different refractive indices for light polarized in different directions. When linearly polarized light passes through a quarter-wave plate, the phase shift introduced between the fast and slow axes causes the light to exit as circularly polarized or elliptically polarized, depending on its initial orientation relative to the plate's axes. The light beam output from the circular polarizer 128 is then directed through a circular polarization switcher 114, which in an example embodiment can be a switchable liquid crystal half wave plate (SLC-HWP). In the T1 state the circular polarization switcher 114 acts as a half wave plate, switching the handedness of incoming circularly polarized light to the opposite handedness of polarization, in this case from left-handed circularly polarized light 74 to right-handed circularly polarized light 76.

Light is an electromagnetic wave, and the electric field of a light wave oscillates perpendicularly to the direction of propagation. Light is called unpolarized if the direction of this electric field fluctuates randomly in time. Many common light sources such as sunlight, halogen lighting, LED spotlights, and OLEDs produce unpolarized light. In an attempt to confine the electric field of light to a single plane, unpolarized light from a light source, such an OLED, can be passed through a linear polarizer. As illustrated in FIG. 9, the light transmitted through the linear polarizer 110 is confined to the x-z plane and the light not confined to this plane is absorbed or reflected. A linear polarizer can be optimized for system efficiency or for a desired extinction ratio ρ, and the function of the system being designed will determine whether efficiency or the extinction ratio ρ is a greater priority. In the case of the disclosed optical system, system efficiency is generally the higher priority on the basis that there are additional optical components in the system after the linear polarizer 110 and the intensity of each pixel must increase depending on the magnitude (2×, 4× etc.) of the time division multiplexing. Additionally, for proper wavefront reconstruction, the output of each TDM state must overlap directionally with each other state. Therefore, crosstalk between TDM states is not detrimental to performance and large extinction ratios are not required of the linear polarizer. In one embodiment, the linear polarizer has an extinction ratio greater than 100. Preferable examples of linear polarizer 110 for the disclosed optical system are a wire grid polarizer or a dichroic polymer thin film polarizer.

Light exiting through the quarter wave plate 112 is circularly polarized, meaning the electric field of the circularly polarized light consists of two linear components that are perpendicular to each other, equal in amplitude, but have a phase difference of 7/2. The resulting electric field rotates in a circle around the direction of propagation and, depending on the rotation direction, is called left- or right-hand circularly polarized light. For the embodiment shown, the quarter wave plate 112 converts linearly polarized light 104 into circularly polarized light, and in this example, converts linearly polarized light 104 into left hand circularly polarized light (LHCPL) 74. The circularly polarized light transmitted by the quarter wave plate 112 is either RHCPL or LHCPL, depending on the direction of rotation of the electric field. A quarter wave plate 112 can comprise, for example, a birefringent material such as, for example, liquid crystal, quartz, or magnesium fluoride. The left hand circularly polarized light (LHCPL) 74, as exemplified in FIG. 9, is then directed through a controllable circular polarization switcher 114, which can be, for example, a switchable liquid crystal half wave plate (SLC-HWP). The thickness of the liquid crystal layer in a SLC-HWP is selected so that it acts as a half wave plate (HWP) resulting in a retardation value of half a wavelength (λ/2). A half waveplate (HWP) will change RHCPL to LHCPL, and vice versa. However, in the time domain multiplexing device shown, the circular polarization switcher is controllable, such that the system can elect to either change or conserve the directionality of the circularly polarized light passing through it. In an embodiment, the SLC-HWP can comprise a liquid crystal cell consisting of a substrate, an active electrode, an alignment layer, a liquid crystal material, and a second common electrode. Both electrodes are connected to a driving circuit. The liquid crystal material in a switchable liquid crystal half wave plate is birefringent and therefore can be used to manipulate the polarization of light, and the orientation of the liquid crystal molecules is determined by the alignment layer in the absence of an applied voltage. When an AC voltage is applied, the liquid crystal molecules will reorient from their default alignment according to the applied voltage. In one embodiment the liquid crystals in the SLC-HWP are thermotropic and have a rod-like molecular shape. Liquid crystal materials are suitable for optical wave plates as their directionally ordered rod-like molecules have an inherent uniaxial anisotropy and therefore an inherent optical axis. This anisotropy is not only useful in the manipulation of polarization, but in combination with the liquid properties of liquid crystals allows for the reorientation of the optical axis by external forces, such as surface interactions and electric fields. The orientation of the liquid crystals (also known as the director) is determined by surface interactions of crystals with the alignment layer.

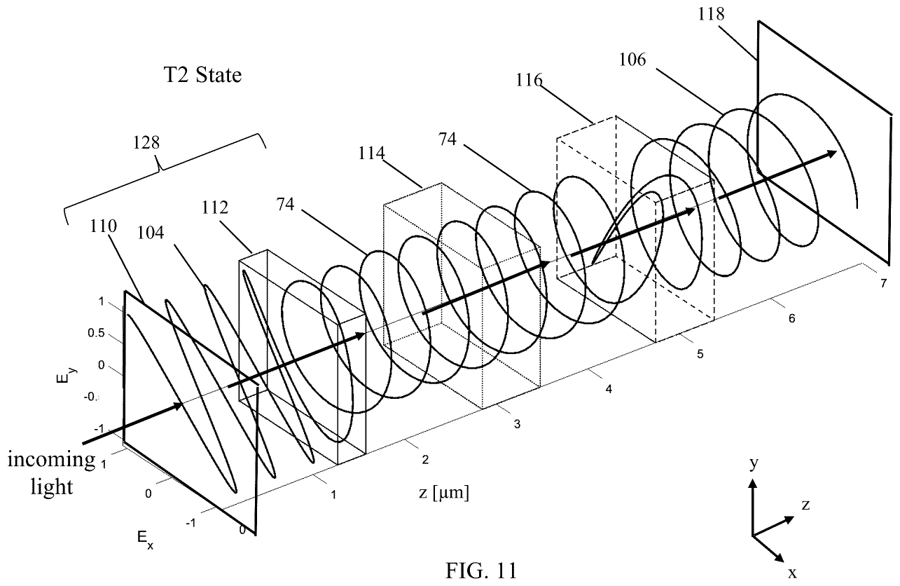

In the T1 state shown, the voltage across the electrodes is below the critical voltage required to induce a change of order in the liquid crystal material away from the default alignment determined by the alignment layer, thus the handedness of the incident circularly polarized light is switched to the opposite handedness. In this case, LHCPL is switched to RHCPL when insufficient voltage is applied across the SLC-HWP. The switchable nature of the SLC-HWP is achieved by applying an AC voltage across the electrodes that induces a dipole moment in the rod-like structure of liquid crystal molecules in the SLC-HWP. Above a certain applied voltage across the electrodes the structure of the liquid crystals will align such that the optical axis of the liquid crystal material is parallel to the display plane, preventing a circular polarization reversal in the incident light. This is referred to as the T2 State, shown in FIG. 11. The field applies a force on the liquid crystal molecules that reorients the liquid crystal molecules so that the director is parallel to the electric field. As the electrodes are planar the electric field will be normal to the display, therefore, the optical axis will also be perpendicular to the display. In the T2 state the polarization state of light travelling parallel to the optical axis is unaltered by the SLC-HWP. Thus, in the T1 state as shown in FIG. 9, the SLC-HWP acts as a half wave plate, switching the handedness of circularly polarized light. In the T2 state the SLC-HWP does not act on the polarization state, maintaining the polarization state of circularly polarized light, thereby achieving the ability to switch between two orthogonal polarization states.

As shown in FIG. 9, light transmitted by the circular polarization switcher 114 in the T1 state becomes circularly polarized in the opposite direction, which, in the case of FIG. 9, is from LHCPL 74 to RHPCL 76. This new handedness of circularly polarized light is then transmitted to a polarization-sensitive beam deflector 116 which acts opposingly on RHCPL and LHCPL, creating two distinct states. The polarization-sensitive beam deflector 116 is preferably a Pancharatnam-Berry Beam Deflector (PBBD). The Pancharatnam-Berry phase is a geometric phase associated with the polarization of light. When a beam's polarization traces a closed loop on the Poincard sphere, the phase of its final state differs from its initial state by half the area enclosed by the loop. For a case where circular polarized light is incident on a wave plate with constant retardation and a continuous space-varying fast axis, the orientation can be denoted by:

$$θ ( x , y )$$

If the wave plate is space varying, the beam at different points traverses different paths on a Poincaré sphere, resulting in a space-variant phase-front modification that originates from the Pancharatnam-Berry phase. If a circularly polarized beam is incident on a space-variant polarization state manipulator, such as a PBBD, it is subject to geometric phase modification. The resulting wave consists of two components: the zero order and the diffracted order. The zero order has the same polarization as the original wave front and does not undergo any phase modification. Contrastingly, the diffracted order has polarization orthogonal to that of the incoming wave, and its phase at each point is equal to twice the local orientation of wave plate θ(x, y).

In the present system, a case of special interest is when the beam deflector is Pancharatnam-Berry Optical Element (PBOE), which is a half wave plate where the phase of electric field along the slow axis is retarded by pi, ϕ=π, wherein the diffraction efficiency is 100% and right hand circularly polarized light (RHCPL) is transformed to left hand circularly polarized light (LHCPL), or vice versa. In an embodiment of the present disclosure, the deflection angle of the polarization sensitive beam deflector or PBBD is set so the apparent position of the deflected light, or subpixels in the case of pixel array, is shifted by a quarter the pixel pitch, σ/4, in x and y, such that the apparent origins of RHPCL and LHCPL are offset by σ/2 in x and y, resulting in the direction of RHPCL and LHCPL being offset by Φ/2 in yaw and pitch. This deflection in yaw and pitch maintains the directional aspect ratio of the hogel equal to the positional aspect ratio of the subpixels. The PBBD thus reverses the handedness of the circularly polarized light transmitted by the circular polarization switcher 114.

The polarization sensitive beam deflector 116 optical component is preferably achromatic with a submicron thickness and high transmissivity (>90%). The polarization sensitive beam deflector 116 may be, for example, a Switchable Liquid Crystal (SLC) element or a polymerized Liquid Crystal film. In an embodiment of the present disclosure, the polarization sensitive beam deflector 116 is coplanar or approximately coplanar with a directional optical element 118, such as a resonant metasurface, metalens, or lens array, which serves as a directional optical element such that the deflection angle of the polarization sensitive beam deflector 116 corresponds to an apparent subpixel position shift of a quarter the pixel pitch, σ/4, in x and y is a quarter the angular pitch, Φ/4, in yaw and pitch.

Optical metasurfaces can shape the amplitude, phase, and polarization of electromagnetic beams. The use of metasurfaces in light field display technology can enable the creation of virtually flat optical devices, improve the performance of optical elements, and manipulate light to provide optical systems with new properties. In development of light field display technology, metasurfaces have shown promising potential as lightweight and thin optical components that may combine several functionalities into a single device. Optical metasurfaces, also referred to as engineered metasurfaces or resonant metasurfaces, are engineered surfaces used to manipulate a wavefront. Resonant metasurfaces generally consist of an array of sub-wavelength resonant nanostructures that are tuned to locally control the phase of light, for example in a lattice of pillar-type structures. These resonant nanostructures typically consist of high-index cylindrical nanopillars of a fixed height. The nanostructures interact with an impinging wavefront where the lattice constant and structure size are of subwavelength thickness relative to the electromagnetic wavelength range that the structures are designed to interact with. The design of dimensions of the resonant nanostructures or pillars and the pillar spacing in the metasurface are varied to obtain desired optical properties. The phase imparted on light by the nanopillars can be tuned by varying the pillar diameter. An arbitrary phase mask (i.e. a metasurface) can be constructed from a set of pillar diameters that correspond to a range of phase shifts that span 2π. As cylinders are rotationally invariant, they impart the same phase on orthogonal polarizations of light, therefore, the difference in TDM states is determined by the slight deflection of light by the polarization sensitive beam deflector 116 prior to interaction with the resonant metasurface 28. The directional optical element 118 can also be, for example, a polarization insensitive metalens that acts as the directional element of each hogel.

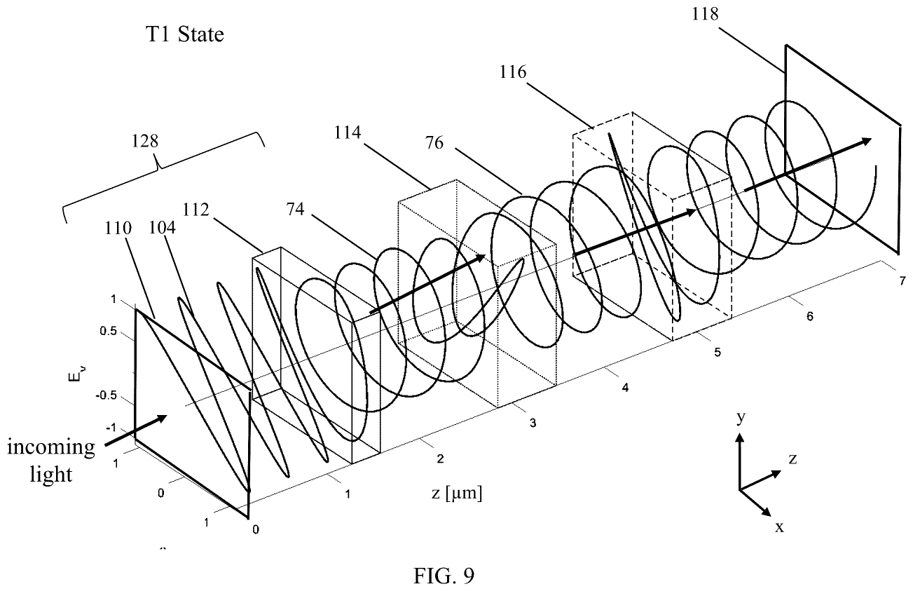

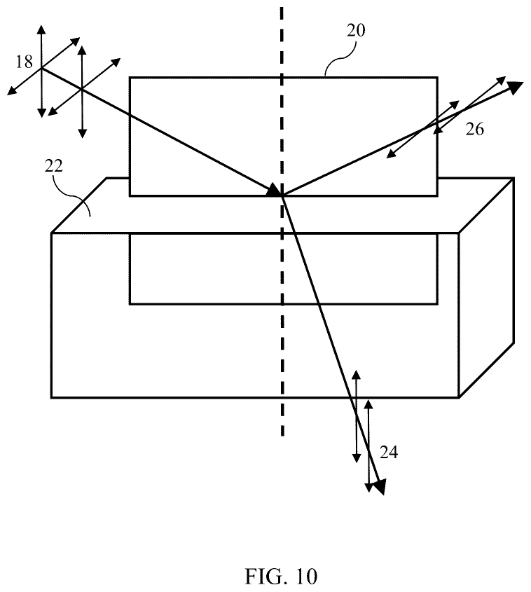

FIG. 10 illustrates linear polarizations of incident light defined by their relative orientation to the plane of incidence. Shown are the two orthogonal linear polarization states: p-linear polarized light 24 and s-linear polarized light 26. Incident light 18 can be considered a rapidly varying random combination of p- and s-polarized light and p- and s- are linear polarizations defined by their relative orientation to the plane of incidence 20. P-polarized light 24 has an electric field polarized parallel to the plane of incidence 20 and s-polarized light is perpendicular to this plane 20 relative to the incident surface 22. For the disclosed optical system, the linear polarizer can be selected to transmit either of the linear polarization states. To select a specific polarization of light a polarizer is used. Polarizers can be broadly divided into reflective, dichroic, and birefringent polarizers. A linear polarizer will transmit only one of p- or s-polarization of the incident light ray, while absorbing and/or reflecting the remaining polarization. Efficiency is the dominant design consideration for the linear polarizer for the presently described system as the intensity of the selected linearly polarized light is reduced to 50% of the input incident light. It is this required intensity that dictates that the design of the linear polarizer in the present system be based upon maximum system efficiency versus extinction ratio ρ. In some instances the generated light beam from the linear polarizer is approximately 50% p-polarized light and 50% s-polarized light. In other embodiments the linear polarizer transmits one of p-polarized light or s-polarized light and absorbs non-transmitted p-polarized light or s-polarized light, thereby reducing the intensity of the light beam by 50%. In another embodiment the linear polarizer transmits one of p-polarized light or s-polarized light and reflects the non-transmitted p-polarized light into s-polarized light, or vice versa. If the light source is a microcavity and there is an anisotropic medium between the reflecting linear polarizer and top reflective surface of the microcavity then the previously reflected p-polarized light or s-polarized light can be transformed into s-polarized light or p-polarized light which can pass through the reflective linear polarizer. Using this transformation of the undesired polarization to the desired polarization all of the light emitted from the incoming light source can be used to create the light field.

The extinction ratio ρ is determined by measuring light intensity from an unpolarized light source passing through a set of two linear polarizers. When the polarizers are oriented parallel to each other, referred to as parallel intensity, the measured intensity is maximized. Conversely, when the linear polarizers are oriented perpendicularly, the intensity is minimized. This orientation is known as the crossed intensity. The extinction ratio ρ is the ratio of the parallel intensity to the crossed intensity such that a higher extinction ratio ρ corresponds to a higher quality linear polarizer. The effect of the extinction ratio ρ on display perception is captured by considering the Modulation Transfer Function (MTF) of the display. To properly define the modulation transfer function, it is necessary to first define two terms required to characterize image performance: resolution and contrast. Resolution is an imaging system's ability to distinguish object detail and is often expressed in terms of line-pairs per millimeter, where a line-pair is a sequence of one black line and one white line. This measure of line-pairs per millimeter

$$( \frac{lp}{mm} )$$

is also known as frequency. The inverse of the frequency yields the spacing in millimeters between two resolved lines. Contrast or modulation can then be defined as how faithfully the minimum and maximum intensity values are transferred from the object plane to an image plane. The MTF of an optical component, or lens, is a measurement of its ability to transfer contrast at a particular resolution from the object to the image. In other words, MTF is a way to incorporate resolution and contrast into a single specification. As the views of the TDM states are interleaved, the MTF of the display can be found by setting one of the TDM states to black and the other to white. The extinction ratio ρ will contribute to the MTF as the views corresponding to the TDM black state will receive light while the views corresponding to the TDM white state will be inversely proportional to the extinction ratio ρ.

FIG. 11 illustrates the light polarization transformation of light rays through a time division multiplexing system in the T2 state. In the T2 state, in a circular polarization switcher 114 such as a switchable liquid crystal half wave plate (SLC-HWP), a voltage is applied across the liquid crystal such that the crystal structure does not act on the polarization state of the incident light. This maintains the incident polarization state of circularly polarized light, thus achieving the ability to switch between two orthogonal polarization states. In this way, rapid circular polarization switching times on the order of milliseconds can be achieved, which is faster than can be perceived by a human eye and therefore useful for TDM. To confine the electric field of light to a single plane, unpolarized light incoming light from a light source, such as for example an OLED, is passed through a linear polarizer 110. Light transmitted by the linear polarizer 110 is thereby confined to the x-z plane and the light not confined to this plane is absorbed or reflected. The linear polarizer 110 can be optimized for system efficiency or for a desired extinction ratio ρ and the function of the system being designed will determine whether efficiency or the extinction ratio ρ is a greater priority. In the case of the presently described time domain multiplexing optical system, regardless of system state, system efficiency is of high priority. Linearly polarized light 104 transmitted by the linear polarizer 110 which then travels through a quarter wave plate 112, together referred to as a circular polarizer 128. In an embodiment, the linear polarizer and quarter wave plate can be a single combined circular polarizer component that converts non-polarized light into circularly polarized light.

Waveplates, also known as retarders, transmit light and modify its polarization state without attenuating, deviating, or displacing the beam by retarding or delaying one component of polarization with respect to its orthogonal component. Retardation describes the phase shift between the polarization component projected along the fast axis and the component projected along the slow axis. Retardation is specified in units of degrees, waves, or wavelength such as nanometers. One full wave of retardation is equivalent to a 360° phase shift and popular retardation values are λ/4, λ/2, and 1λ, but other values can be useful in certain applications. A wave plate can be a multiple order wave plate or a zero order waveplate. In a multiple order wave plate the total retardation value is equal to the desired retardation value plus an integer number of wavelengths. The total retardation of a zero-order wave plate is the desired value without excess. Transmission of the linearly polarized light 104 through the quarter wave plate 112 results in a quarter wave (λ/4) retardation and, in this exemplified case, left hand circularly polarized light (LHCPL) 74. The quarter wave plate 112 may be formed of a birefringent material, such as liquid crystals, quartz, or magnesium fluoride. Ideally, a quarter wave plate 112 for the disclosed optical system is a zero-order wave plate with high transmissivity (≥95%) and is relatively thin (25-35 nm).

Light transmitted by the quarter wave plate 112 is circularly polarized, in this example LHCPL 74. The electric field of circularly polarized light consists of two linear components that are perpendicular to each other, equal in amplitude, but have a phase difference of π/2. The resulting electric field rotates in a circle around the direction of propagation and, depending on the rotation direction, is called left- or right-hand circularly polarized light. Selected waveplates can convert light from a first polarization state into a new polarization state, and are often used to rotate linear polarized light. In this embodiment, the quarter wave plate 112 can convert linearly polarized light 104 to circularly polarized light. The circularly polarized light LHCPL 74 is then directed through a circular polarization switcher 114, which can be a switchable liquid crystal half wave plate (SLC-HWP). In one example, a SLC-HWP comprises a substrate, an active electrode, an alignment layer, a liquid crystal material, and a second common electrode. Both electrodes in a SLC-HWP are connected to a driving circuit connected to a control system. The liquid crystal material in a SLC-HWP is birefringent and therefore can be used to manipulate the polarization of light. In one embodiment the liquid crystals are thermotropic and have a rod-like molecular shape. Liquid crystal materials are suitable for optical wave plates as their directionally ordered rod-like molecules have an inherent uniaxial anisotropy and therefore an inherent optical axis. This anisotropy is not only useful in the manipulation of polarization, but in combination with the liquid properties of liquid crystals allows for the reorientation of the optical axis by external forces, such as surface interactions and electric fields. The thickness of the liquid crystal layer of a SLC-HWP is chosen so that it acts as a half wave plate (HWP) resulting in a retardation value of half a wavelength (π/2). The circularly polarized light transmitted by the quarter wave plate 112 is either right hand circularly polarized light (RHCPL) or left hand circularly polarized light (LHCPL), depending on the direction of rotation of the electric field. A HWP will change RHPCL to LHCPL, and vice versa.

In the T1 state shown in FIG. 9, the voltage across the electrodes in the circular polarization switcher 114, as controlled by the driving circuit and control system, is below the critical voltage required to induce order in the liquid crystal material, therefore, the orientation of the liquid crystals (also known as the director) is determined by surface interactions with the alignment layer, such that the optical axis is parallel to the display plane. The switchable nature of a SLC-HWP is achieved in the T2 state shown in FIG. 11 by applying an AC voltage on the order of 5-25V across the electrodes in the circular polarization switcher 114 that induces a dipole moment in the rod-like structure of the liquid crystal molecules. The electric field applies a force on the liquid crystal molecules that reorients the molecules so that the director is parallel to the electric field. As the electrodes are planar the electric field will be normal to the display, and the optical axis will also be perpendicular to the display. The polarization state of light travelling parallel to the optical axis is thereby unaltered by the SLC-HWP, such that circularly polarized light transmitted by the circular polarization switcher 114 is the same handedness as the circularly polarized light transmitted by the QWP. In the example of FIG. 11 when a sufficient electric field is applied to the SLC-HWP circular polarization switcher 114, the handedness of the LHCPL 74 is unaltered as it is transmitted through the SLC-HWP in the T2 state. In this way, in the T1 state the SLC-HWP acts as a HWP switching the handedness of circularly polarized light and in the T2 state the SLC-HWP does not act on the polarization state maintaining the polarization state of circularly polarized light, thus achieving the ability to switch between two orthogonal polarization states. As seen in FIG. 11, light transmitted by the circular polarization switcher 114 in the T2 state has maintained its previous polarization state as LHCLP and is transmitted to a beam deflector 116. It is noted that this embodiment encompasses either RHCPL or LHCPL, depending on the circular handedness introduced by the quarter wave plate 112.

When the light entering polarization sensitive beam deflector 116 is circularly polarized, the polarization sensitive beam deflector 116 imparts a geometric phase modification on the circularly polarized light beam of a first handedness to a first angle in a first direction, and imparts a geometric phase modification on the circularly polarized light beam of a second or reversed handedness to a second angle in a second direction. In an embodiment of the present disclosure, the deflection angle of the polarization sensitive beam deflector 116 is set so the apparent position of subpixels from the incoming light source is shifted by a quarter the pixel pitch, σ/4, in x and y, such that the apparent origins of RHPCL and LHCPL are offset by σ/2 in x and y, resulting in the direction of RHPCL and LHCPL being offset by Φ/2 in yaw and pitch. This deflection in yaw and pitch maintains the directional aspect ratio of the hogel equal to the positional aspect ratio of the subpixels. The polarization sensitive beam deflector 116 thereby reverses the handedness of the circularly polarized light transmitted by the circular polarization switcher 114. The polarization sensitive beam deflector 116 can be chromatic with a submicron thickness and have high transmissivity (>90%). The polarization sensitive beam deflector 116 may also be a Switchable Liquid Crystal (SLC) element or a polymerized Liquid Crystal film. The polarization sensitive beam deflector 116 is preferably a switchable beam deflector, such as, for example, a Pancharatnam-Berry Beam Deflector (PBBD). Like the T1 state of the optical system illustrated in FIG. 9, circularly polarized light 106 transmitted by the polarization sensitive beam deflector 116 is further directed to a directional optical element 118, which can be a Resonant Metasurface (RM). In another embodiment of the present disclosure, the polarization sensitive beam deflector 116 is coplanar or approximately coplanar with the directional optical element 118 such that the deflection angle of the beam deflector 116 corresponds to an apparent subpixel position shift of a quarter the pixel pitch, σ/4, in x and y, which is a quarter the angular pitch, Φ/4, in yaw and pitch.

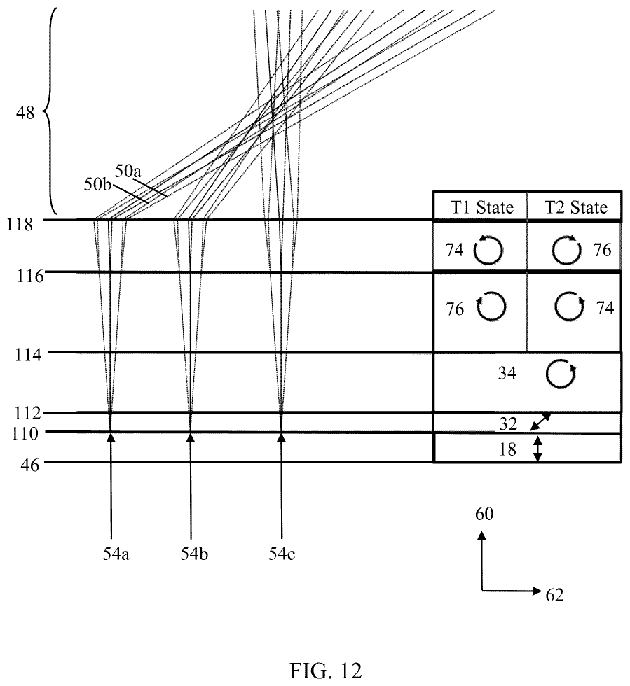

FIG. 12 illustrates the ray paths for three red subpixels (54a, 54b, 54c) of three separate pixels, where each red subpixel 54a, 54b, 54c corresponds to a different location within a hogel, such as near the edge of a hogel, a quarter hogel pitch toward the center from the hogels edge, and at the hogel center x=[0, σ/4, σ/2], for each of the optical system states (i.e., the T1 state and the T2 state). The vertical axis 60 is the position along z in microns and the horizontal axis 62 is the position in x in microns. In the present embodiment, the light source 46 is an OLED array, specifically a MCOLED array. It is understood that the light source 46 for the disclosed optical system may be comprised of, for example, Light Emitting Diodes (LEDs), projector devices, Organic Light Emitting Diodes (OLEDs), electroluminescent (EL) devices, or any other light source producing unpolarized light. Structurally, the light source 46 and the linear polarizer 110 are depicted as coplanar in the z=0 plane. It is noted that the position of the beam deflector 116 is illustrated as close to circular polarization switcher 114, and its deflection angle is exaggerated for illustrative purposes. Red subpixels 54a, 54b, 54c generate unpolarized incident light 18, meaning the direction of the electric field of the light fluctuates randomly in time. For clarity, the incident light 18 emitted by the light source 46, specifically by subpixels 54a, 54b, 54c, is illustrated as a single line. As per the embodiment of the optical system illustrated in FIG. 12, subpixels 54a, 54b, 54c are a single color, i.e. red (R). It is understood that subpixels 54a, 54b, 54c can also be a single color of green (G) or blue (B). It is assumed that for a RGB pixel display, each red subpixel (54a, 54b, 54c) will have at least two corresponding subpixels, for example one green (G) subpixel and one blue (B) subpixel, within a single hogel, where each corresponding subpixel has the same output angle in the light field 48. For example, if subpixels 54a, 54b, 54c are red (R) subpixels, each of subpixels 54a, 54b, 54c have a corresponding green (G) subpixel and blue (B) subpixel in the display. Like colored subpixels 54a, 54b, 54c are clustered together in the present embodiment to simplify the design of the directional optical element 118.

Each subpixel within a pixel is driven by one or more pixel drivers. As per the present illustrative embodiment, the subpixels 54a, 54b, 54c are single-colored red subpixels, each belonging to a separate pixel within a different hogel. As previously described, a hogel is a directional light emitting structure that emits light of different color and intensity in different directions comprising a plurality of subpixels each with a specific output angle, thereby forming an output light field 48. A pixel driver circuit controls the subpixel and drives different voltages to the light emitting devices to achieve different colors and intensities. In an array of subpixels, an array of pixel driver circuits operatively connected to each subpixel sits behind each subpixel in the array. The pixel driver circuit can be a sample and hold circuit where each directional pixel in an array is updated sequentially, such that as each circuit in the array of pixel driver circuits drives the data to its associated subpixel, the subpixel samples and holds its value until new data is available to update it.

In an embodiment of the disclosure, each red subpixel 54a-c can be a microcavity OLED (MCOLED) comprising a cathode, that doubles as a bottom reflective surface of the microcavity, and a conducting material. The thickness of the cathode in an MCOLED is generally designed to increase reflectivity and reduce unwanted phase changes. The microcavity light propagating reflective surface or upper reflective surface of each subpixel can also have dielectric layers comprising, for example, titanium dioxide and silicon dioxide. The light propagating reflective surface is highly reflective, allowing only a small portion of the light to escape, and the light propagating reflective surface advantageously has no absorption due to its dielectric composition. The reflectance of the light propagating reflective surface can be tuned by, for example, increasing the number of dielectric pairs. Each of the dielectric layers has an optical path length of/4. The optical path length of the dielectric layers differs from the thickness of the dielectric layers because the path length accounts for the distance the light travels within the optical cavity. Because the optical path of the dielectric layers is a mode of the predetermined wavelength, the light propagating reflective surface is a highly reflective mirror for both the specified wavelength and a range of wavelengths surrounding the center wavelength. When the light emitting device emits light, the light beams reflect between the two reflective surfaces which act as mirrors. With constructive interference at the center peak and destructive interference surrounding the center peak, the light rays perpendicular to the mirrors are emitted from the light propagating reflective surface, thereby creating substantially collimated, manipulated, or tuned light with a reduced spectral bandwidth.

Light generated by an MCOLED subpixel light source 46 is unpolarized incident light 18 and is directed to a linear polarizer 110. The linearly polarized light 32 transmitted by the linear polarizer 10 is the same for the T1 state and the T2 state. Linearly polarized light 32 is then directed to a quarter wave plate 112 wherein it becomes circularly polarized light 34. For illustrative purposes, light transmitted by the quarter wave plate 112 is shown as left-handed circularly polarized light (LHCPL), however it is understood that the light from the quarter wave plate 112 could also be right handed circularly polarized light (RHCPL). More importantly, the T1 state circularly polarized light and the T2 state circularly polarized light will have the same handedness before entering the circular polarization switcher 114. After circular polarization by quarter wave plate 112, the circularly polarized light 34 is then directed to a circular polarization switcher 114. In a switchable liquid crystal half wave plate (SLC-HWP) acting as a circular polarization switcher 114, the liquid crystals (LC) are birefringent and can be used to manipulate the polarization of light by acting as a wave plate. In the T1 state of the system (i.e., no electrical current supply), the SLC-HWP will impart a retardation of half a wavelength reversing the handedness of the circularly polarized light transmitted by the quarter wave plate 112. Alternatively, in the T2 state of the system (i.e., electrical current is applied) the SLC-HWP will not retard the light and instead allow the circularly polarized light to pass through without modification of its polarization. The switchable nature of the SLC-HWP in response to electrical current or voltage applied to the sensitive liquid crystal allows the transmission of light rays of two orthogonal polarization states, shifted by a phase of λ/2. In the case shown, where the initial circularly polarized light 34 is left-handed circularly polarized light (LHCPL), LHCPL will be transmitted through the SLC-HWP depending on the state of the circular polarization switcher 114. In the T1 State the polarization of light is reversed from LHCPL to RHCPL as it is transmitted by the SLC-HWP; in contrast, the polarization of light is retained as LHCPL when transmitted through the SLC-HWP in the T2 state.

Once leaving the circular polarization switcher 114, the circularly polarized light is then directed to a polarization sensitive beam deflector 116, which can be a Pancharatnam-Berry Beam Deflector (PBBD). At the beam deflector 116, the handedness of each circularly polarized incoming beam is reversed, causing the RHCPL 76 in the T1 state to switch to LHCPL 74, and the LHCPL 74 in the T2 state to switch to RHCPL 76. The polarization sensitive beam deflector 116 may be, for example, a metasurface, which acts as a linear phase mask such that the wavefront transmitted is travelling at an angle of θ from the display normal. This is achieved when the phase gradient meets the following condition:

$$\frac{d ϕ}{d x} = - \frac{2 π}{λ o} sin θ$$

To find the required phase periodicity, x, to reproduce a linear phase mask set:

$$d ϕ ∼ Δ ϕ = 2 π$$

### Therefore:

$$x = - \frac{λ o}{sin ( θ )} \approx - \frac{λ o}{θ}$$

From the polarization sensitive beam deflector 116, the light is then directed through a directional optical element 118 when it contributes to generation of light field 48. As shown, light from subpixel 54a is deflected based on whether it is in the T1 State or T2 state, creating two different light beams 50a and 50b.

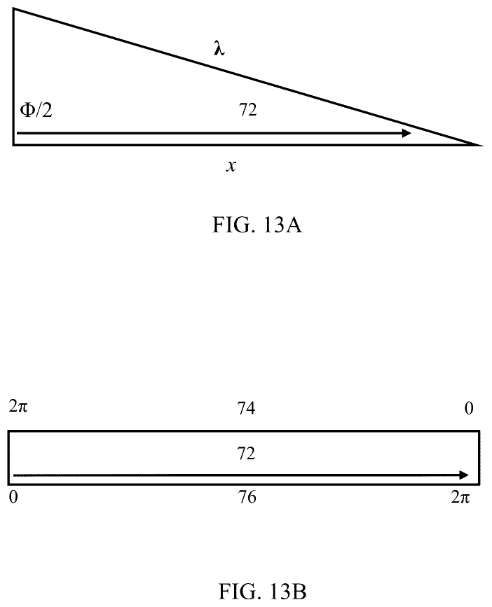

FIG. 13A is a geometric illustration of a linear phase mask. A linear phase mask is an optical element designed to impose a linear variation in phase across an incident wavefront. This induced phase variation can lead to specific optical effects, such as beam steering or focus adjustment. Linear phase masks have widespread applications in fields like holography, beam steering, and diffractive optics. A linear phase profile can be mathematically described as:

$$ϕ ( x ) = β x + {ϕ}_{0}$$

where ϕ(x) is the phase as a function of position x, β represents the linear phase gradient 72, and ϕ₀ is a constant offset. This linear phase gradient across a wavefront causes changes in the light's propagation direction, which is critical in various applications.

Linear phase masks can be created using different techniques and structures, each offering unique advantages, such as, for example, Diffractive Optical Elements (DOEs), Metasurfaces, and Spatial Light Modulators (SLMs). Diffractive Optical Elements (DOEs) use microstructures to create specific phase patterns. The phase shift across the DOE is determined by varying the height or spacing of these structures. Metasurfaces are comprised of sub-wavelength-scale elements known as meta-atoms, which can induce specific phase shifts through their orientation or other attributes. By organizing these meta-atoms to generate a linear phase gradient, metasurfaces can effectively steer or shape light. Spatial Light Modulators (SLMs) generally consist of electronically controlled pixels, enabling real-time phase manipulation. This flexibility allows for dynamic control of the linear phase gradient, providing versatility in optical setups. Linear phase masks are fundamental in several optical domains, including beam steering, focusing and lens application, and in holography. In beam steering, a linear phase gradient can deflect a beam at a specified angle. This property is utilized in optical communication systems, remote sensing, and other beam manipulation applications. In focusing and lens applications, a linear phase gradient can be employed in optical lenses to focus or disperse light, allowing for compact and versatile lens designs. In holographic systems, linear phase masks can generate complex interference patterns, crucial for image reconstruction and other holographic techniques. Linear phase masks are powerful tools in optics, providing a way to control light through phase manipulation. The linear phase gradient, whether implemented via DOEs, metasurfaces, or SLMs, opens up a broad range of applications in both research and practical optical systems.

FIG. 13B illustrates a linear phase gradient 72 for a Pancharatnam-Berry Beam Deflector (PBBD). The linear phase gradient 72 for a PBBD increases from 2π to 0 for LHCPL 74. In contrast, the linear phase gradient 72 increases from 0 to 2π for RHCPL 76. The Pancharatnam-Berry (PB) phase, also known as the geometric phase or Berry phase, is a concept used in optics and photonics that leverages geometric transformations in polarization space to create unique effects, such as those achieved by a Pancharatnam-Berry beam deflector. This approach is utilized in metasurfaces and diffractive optics to control light propagation in innovative ways. A Pancharatnam-Berry (PB) beam deflector typically operates by imposing a spatially varying geometric phase across the metasurface, resulting in a controlled deflection of the incident light beam. The spatial variation in phase depends on the local orientation of optical elements or the optical axis in the metasurface. The underlying principle is that changing polarization leads to a phase shift due to the geometric transformation in polarization space.

In a typical PB beam deflector design, the key component is a metasurface composed of sub-wavelength-scale elements, often called “meta-atoms”, that induce local polarization rotations, including spatially varying polarization rotation and phase shift through polarization rotation. In spatially varying polarization rotation, the metasurface elements are arranged so that their orientation varies linearly across the surface. This linear gradient in orientation creates a corresponding linear phase gradient in the outgoing light. In phase shift through polarization rotation, when light with a specific polarization state (e.g., circular polarization) hits the metasurface, it undergoes a phase shift that is dependent on the orientation of the meta-atoms. This phase shift is calculated based on the Pancharatnam-Berry phase, which is proportional to the orientation angle of the meta-atom. By arranging the meta-atoms with a linearly varying orientation, a linear phase gradient is created. This phase gradient is crucial in determining the deflection angle of the transmitted or reflected light beam. Mathematically, the gradient can be described by a function that relates the phase shift to the spatial coordinates on the metasurface. The deflection angle can be calculated from the phase gradient using the grating equation. The linear phase gradient causes the incident light to be deflected at a specific angle, which depends on the gradient's magnitude and direction. This technique is used in various applications, such as beam steering, holography, and compact optical devices. μ

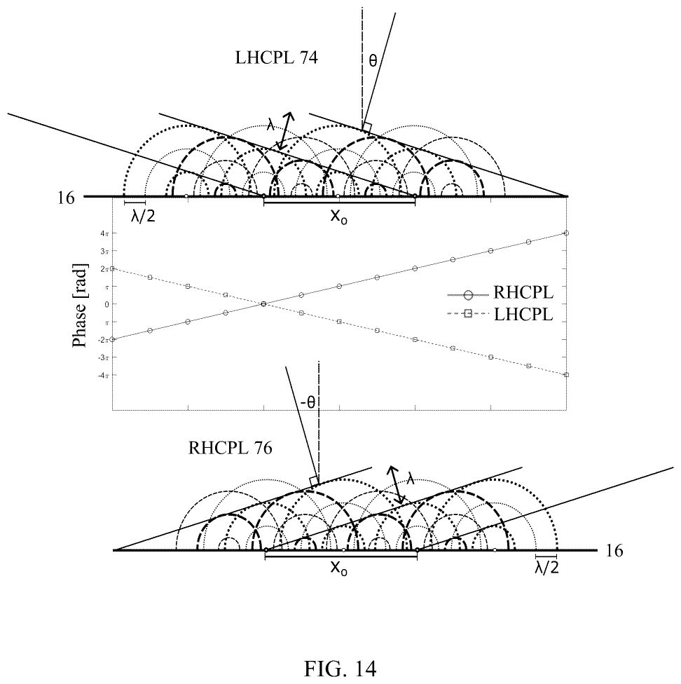

FIG. 14 is a representation of a wavefront transmitted by a Pancharatnam-Berry Beam Deflector (PBBD) 16 using Huygens principle for both RHCPL 76 and LHCPL 74, which states every point on a wavefront is a source of spherical wavelets and that these wavelet sources cause mutual interference. The spherical wavefronts originating from eight regularly spaced points on the PBBD 16 are traced, and each of these points lies at the center of a set of concentric wavefronts. Each wavefront within a concentric set is separated by half a wavelength such that all the bold lines represent the crest of the wave and all the dashed lines represent the troughs. The PBBD 16 imparts a phase that increases linearly with position for RHCPL 76 and decreases linearly with position (with the opposite slope) for LHCPL 74. The graph central to FIG. 14 plots the phase imparted by the PBBD 16 as a function of position, normalized to xₒ, for both RHCPL 76 and LHCPL 74, which shows there is a constant phase difference between neighbouring points of π/2. If the dotted wavefronts have a phase of either 0 or π at their origin (PBBD surface), then the dashed wavefronts have a phase of π/2 or 3π/2. The PBBD 16 may be a metasurface that uses sub-wavelength nanostructures to locally control the phase of light. Each nanostructure in a Pancharatnam-Berry (PB) metasurface is birefringent and of a length such that it optically behaves as a half-wave plate. Each nanostructure will impart a phase on circularly polarized light, which ranges from 0-27 depending on the orientation of the optical axis of the nanostructure, and the phase imparted on LHCP 74 will be opposite to the phase imparted on RHCP 76 as shown in FIG. 14. An arbitrary phase mask composed of birefringent nanostructures can be fabricated using patterning techniques. Nanostructures may be fabricated using high index-low loss materials suitable for nanopatterning, such as, for example, TiO₂ (titanium dioxide), Si₃N₄ (silicon (IV) nitride) and GaN (gallium nitride). As the deflection angle, θ, of the PBBD 16 is typically less than a degree, the PBBD phase mask can be fabricated using birefringent planar smectic liquid crystals, wherein columns of ordered liquid crystals that act as half wave plates. The orientation of the optical axis of each column can be patterned by a photoalignment layer that imparts a spatial varying direction onto the bulk liquid crystal through surface interactions. Photolithography with a polarized source can be used to pattern photoalignment layers, providing localized control of surface interaction. Existing bulk interaction within the liquid crystal will resist sharp changes in the director, thereby limiting the maximum phase gradients and deflection angle. For deflection angles less than 1 degree and wavelengths greater than 400 nm the grating spacing will be greater than about 45 μm resulting in a small phase gradient.

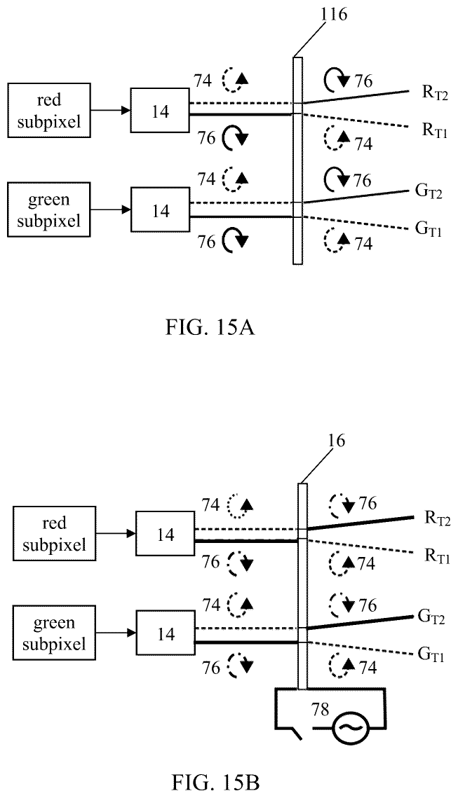

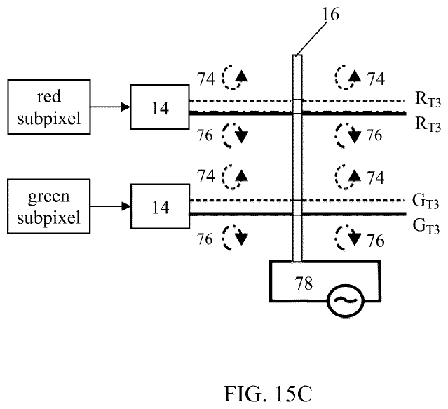

FIG. 15A illustrates a portion of a time domain multiplexing optical system for the ray path of the light beam from a red subpixel and green subpixel in TDM states 1 and 2 passing through a switchable liquid crystal half wave plate (SLC-HWP) 14 followed by a polarization sensitive beam deflector 116. The ray path of a red subpixel after transmission through SLC-HWP 14 in a T1 state followed by polarization reversal and deflection by beam deflector 116 is shown as R_{T1}, and after transmission through SLC-HWP 14 in a T2 state followed by polarization reversal and deflection by beam deflector 116 is shown as R_{T2}. RHCPL is shown with solid lines whereas LHCPL is shown with dashed lines. Similarly illustrated is the ray path of a green subpixel after transmission through SLC-HWP 14 in a T1 state followed by polarization reversal and deflection by beam deflector 116 shown as G_{T1}, and after transmission through SLC-HWP 14 in a T2 state followed by polarization reversal and deflection by beam deflector 116 is shown as G_{T2}. In the R_{T2} example, for the red subpixel, when LHCPL 74 is directed to the polarization sensitive beam deflector 116 after transmission through the SLC-HWP 14 in a T2 state, the light transmitted by the polarization sensitive beam deflector beam deflector 116 is offset by θ in yaw and pitch, and is redirected or transmitted as RHCPL 76. In the other condition after light transmission through the SLC-HWP 14 in a T1 state (R_{T1}), RHCPL 76 directed to the polarization sensitive beam deflector 116 is offset by −θ in yaw and pitch, and subsequently transmitted as LHCPL 74.

FIG. 15B illustrates a portion of an alternative embodiment of a time domain multiplexing optical system for the ray path of light beams from a red subpixel and green subpixel in TDM states T1 and T2, wherein the PBBD 16 is a controllable PBBD, which functions as a beam deflector that can further control the deflection angle of the emitted light beam. In a controllable Pancharatnam-Berry (PB) beam deflector, active control mechanisms allow for toggling of beam deflection. In the absence of a voltage exceeding the critical voltage of the controllable the controllable PBBD behaves just like a PBBD 16.

As illustrated in FIG. 15B, RHCPL is shown with solid lines and LHCPL is shown with dashed lines. In this case a PBBD is connected to an electrical current source 78, which serves as a switchable element and provides a time division multiplexing system in addition to the circular polarization switcher, herein exemplified as a switchable liquid crystal half wave plate (SLC-HWP) 14. In the case shown where no voltage is applied to PBBD 16 the PBBD 16 acts as a circular polarization switcher as well as a beam deflector, switching the polarization of the incoming polarized light and deflecting the circularly polarized light at an angle depending on its circular polarization. The ray path of a red subpixel after transmission through SLC-HWP 14 in a T1 state followed by polarization reversal and deflection by switchable PBBD 16 is shown as R_{T1}, and after transmission through SLC-HWP 14 in a T2 state followed by polarization reversal and deflection by switchable PBBD 16 is shown as R_{T2}.

In the R_{T2} example, for the red subpixel, when LHCPL 74 is directed to the PBBD 16 after transmission through the SLC-HWP 14 in a T2 state, the light transmitted by the PBBD 16 is offset by θ in yaw and pitch, and is redirected or transmitted as RHCPL 76. In the other condition after light transmission through the SLC-HWP 14 in a T1 state (R_{T1}), RHCPL 76 directed to the PBBD 16 is offset by −θ in yaw and pitch, and subsequently transmitted as LHCPL 74. Similarly illustrated is the ray path of a green subpixel after transmission through SLC-HWP 14 in a T1 state followed by polarization reversal and deflection by PBBD 16 shown as G_{T1}, and after transmission through SLC-HWP 14 in a T2 state followed by polarization reversal and deflection by switchable PBBD 16 is shown as G_{T2}. Note that each of beams R_{T1}, R_{T2}, G_{T1}, and G_{T2} are deflected from the normal by PBBD 16.

FIG. 15C illustrates a portion of the optical system, wherein current is applied to the PBBD 16, which is a controllable PBBD in this embodiment, by electrical current source 78. This further embodiment of the disclosed optical system when current is applied to the controllable PBBD from the electrical current source 78 introduces a third time state in addition to the multiplexed time states already introduced by the circular polarization switcher, exemplified here as SLC-HWP 14. As such, an additional TDM state may be reached as illustrated. RHCPL is shown with solid lines and LHCPL is shown with dashed lines. In this case the PBBD 16 is a voltage-controllable PBBD which is connected to an electrical current source 78, and serves as a switchable element and also provides a time division multiplexing system in addition to the circular polarization switcher, herein exemplified as a switchable liquid crystal half wave plate (SLC-HWP) 14. In the case shown where voltage is applied to the PBBD 16, the PBBD 16 does not act on the polarization of the incoming polarized light; therefore, a phase gradient is not imparted of the light and the light is undeflected. In particular, when current is applied to the beam deflector PBBD 16 from the electrical current source 78, a third time state can be introduced wherein the beam exiting the beam deflector is not deflected. This offers three separate views from each beam, specifically for the red pixel, R_{T1}, R_{T2}, and R_{T3}. The switchable nature of the controllable PBBD 16 is achieved in the T3 state by applying an AC voltage across the electrodes that induces a dipole moment in the rod-like structure of liquid crystal molecules. The field applies a force on the liquid crystal molecules in the PBBD that reorients the molecules so that the director is parallel to the electric field. As the electrodes are planar the electric field will be normal to the display; therefore, the optical axis will also be perpendicular to the display. The polarization state of light travelling parallel to the optical axis is unaltered by the PBBD 16. In the T1 and T2 state the PBBD 16 acts as a beam deflecting HWP, switching the handedness of circularly polarized light and deflecting by an angle θ or −θ depending on the incident polarization. In the T3 state the PBBD does not act on the light, maintaining the polarization state and direction of circularly polarized light, thus providing the ability to switch between three deflection angles [θ, 0, −θ] achieving a 3× time division multiplexing.

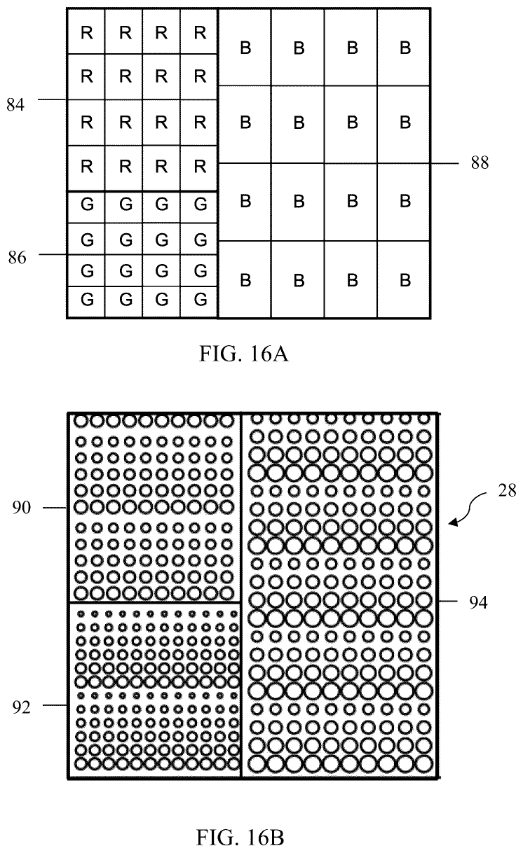

FIG. 16A illustrates a triplet of three monochromatic sub-hogels 84, 86, and 88, which is one embodiment of a sub-hogel configuration for a high-definition light field display that can be used with the present TDM system. As shown, each monochromatic sub-hogel, specifically red sub-hogel 84, green sub-hogel 86, and blue sub-hogel 88, is comprised of 4×4 sub-pixels of a single color. Due to the clustering of the like-colored sub-pixels, a metasurface can be designed with specific properties tailored for each color region. An advantage of this configuration is that the metasurface which acts as the directional optical element, can be designed to have properties specific for a particular wavelength of light, or color. The described sub-hogel structure design and method is suited for an achromatic metasurface to provide directional pixels for multiple view colored light field displays. An efficient broadband achromatic metalens has so far eluded the metasurface research community. To simplify the design of the metasurface for an organic light emitting diode (OLED) or projector-based display, a hogel containing an array of monochromatic sub-hogels is described, wherein each sub-hogel is paired with a unique monochromatic metalens. A hogel is a directional light emitting structure that emits light of different color and intensity in different directions which is comprised of a plurality of sub-pixels. In the present disclosure, hogels are represented with a plurality of RGB subpixels, however it is understood that hogels can comprise different combinations of number and color of sub-pixels. Each pixel consists of sub-pixels, typically three adjacent RGB sub-pixels form a pixel. A pixel array is therefore also a sub-pixel array. In a sub-hogel light field display, the sub-pixel array that makes up each hogel is reorganized such that instead of grouping RGB subpixels of the same pixel together, like-colored sub-pixels are grouped into clusters in order to accommodate the directional optical element, in this case, a metasurface.

FIG. 16B illustrates a metasurface design for a triplet of three sub-hogels. Paired with the sub-hogel design shown in FIG. 16A, forming color regions in the metasurface 28 which are larger than a single sub-pixel allows for a metasurface design that can be practically manufactured. The metasurface color region for red 90 is aligned directly on top of the red sub-hogel 84 as shown in FIG. 16A. Similarly, the metasurface color region for green 92 is aligned directly on top of the green sub-hogel 86, and the metasurface color region for blue 94 is aligned directly on top of the blue sub-hogel 88. Light transmitted by the polarization sensitive beam deflector 116 within the optical system is directed to a directional optical element, which can be, for example, a Resonant Metasurface (RM) or metasurface 28. The metasurface 28 may be comprised of circular nanopillars that impart different phase delays onto light insensitive to polarization. One embodiment of a metasurface 28 design for the disclosed optical system relies upon a sub-hogel display design. A resonant metasurface can be thought of as an ordered spatial-multiplexed metasurface wherein metalenses for each color channel are interleaved onto a single metasurface. The aperture of the metasurface 28 is determined by the sub-hogel size and each sub-hogel interacts with a single-color channel. The presently described RM is segmented to accommodate color regions such each segment has a corresponding cluster of like-colored sub-pixels, allowing for the metasurface color region segment to be tailored to the wavelength of the corresponding sub-pixel cluster. A sub-hogel is a like-colored cluster of sub-pixels coupled with a corresponding metasurface color region segment.

One significant barrier faced in designing directional optical elements and in particular metasurfaces for light field display technology has been achieving a nanoscale pixel size to provide the pixel density necessary for a high-definition light field display, which is on the order of billions of pixels. The presently described RM 28 design achieves a sub-10-micron pixel size while providing adequate sub-hogel size to facilitate a RM 28 design that is manufacturable with known fabrication tools and methods. In order to tailor and achieve an achromatic metasurface with directional pixel capability, it is proposed to cluster like-colored sub-pixels (R, G, B sub-pixels) and layer them with an area of the metasurface tailored to the spectrum of the light emitted by the like-colored (monochromatic) sub-pixel cluster that direct the emitted light, herein referred to as a monochromatic sub-hogel, monochromatic sub-hogel array, and/or monochromatic sub-hogel cluster. A monochromatic sub-hogel design is presently described wherein the clusters of like-colored sub-pixels may be combined with an optical surface, such as a resonant metasurface RM 28, to achieve the directional pixel capability required for a multiple view, 3D light field display. The techniques described herein are advantageous compared with other achromatic metasurfaces. It should be noted that when used in a display, the reduced pixel size allows the system to output a greater number of light beams in a greater number of distinct directions, thus improving upon pixels previously known in the art by allowing the generation of higher angular resolution displays with improved effective resolution of multi-dimensional objects. The increased number of light-field display views allows a viewer located at any viewing position to simultaneously receive multiple views; this is known as a super multi-view (SMV) display. A SMV display, providing improved angular resolution, eliminates the accommodation-convergence conflict and produces displays with a higher quality depth of field.

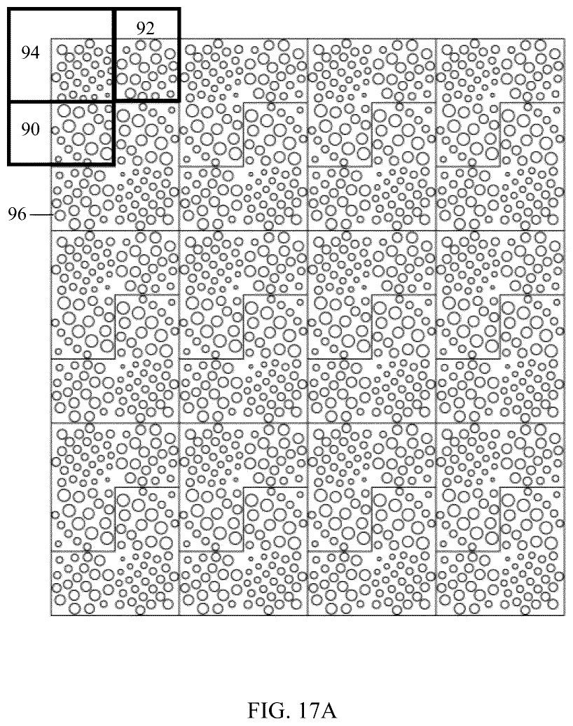

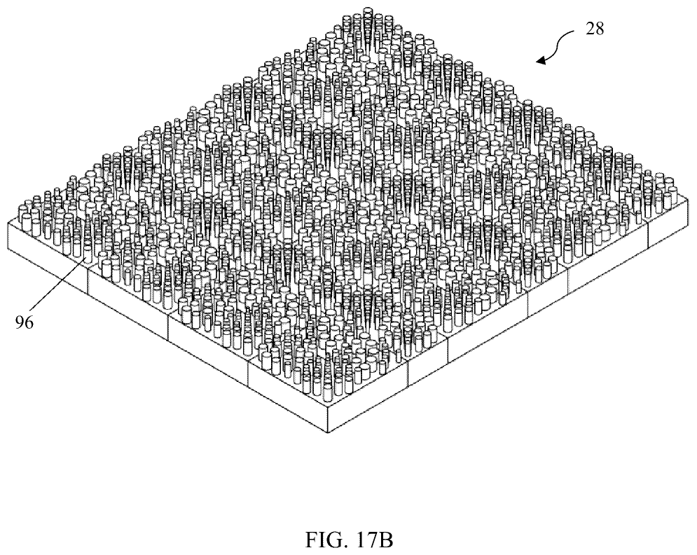

FIG. 17A illustrates a plan view of a metasurface design in an embodiment of the present disclosure, designed for a radial array of 32 monochromatic sub-hogels. The metasurface shown has different color regions for each sub-pixel color, where color region 90 is designed for a red sub-hogel, the metasurface color region 92 is designed for a green sub-hogel, and the metasurface color region 94 is designed for a blue sub-hogel. The metasurface color regions 90, 92, and 94, are comprised of nanopillars 96.

FIG. 17B illustrates an isometric view of a metasurface 28 design in an embodiment of the present disclosure comprising a metasurface tailored for a radial array of 32 sub-hogels and further illustrating an isometric view of the nanostructures, in this case nanopillars 96, comprising the metasurface. Aperture layers can be used to prevent crosstalk between sub-hogels by absorbing stray light. The aperture layer(s) may be patterned on a sub-hogel length scale and may be integrated into any of the above layers. It is preferred that there are at least 1 or 2 aperture layers incorporated into the disclosed optical system, however any practical number is possible. From a fabrication perspective, it is beneficial for all color channels to have uniform layers. The retardance of the waveplates and beam deflectors in the present TDM system can also be designed achromatically by using multi-layered liquid crystal (LC) systems. For spatially multiplexed color channels, the beam deflector or PBBD can be patterned with a different grating constant for different regions of the display. For time domain multiplexed color channels, a single beam deflector or PBBD may result in chromatic aberrations. Potential solutions include 4×TDM with two beam deflectors that each comprise an achromatic doublet or a set of time domain multiplexing systems for each color channel. The circular polarization switcher or SLC-HWP can also be designed to be achromatic by patterning the electrodes so that a unique voltage can be applied to each color channel, such as only for spatially multiplexed color channels, by balancing the dispersion of a chromatic polarization switcher and/or beam deflector, and/or by adding a second liquid crystal compensating layer which can also be switchable. In this case, the circular polarization switcher or SLC-HWP should be achromatic in both states. The directional optical element or RM may be achromatic using sub-hogels. Alternatively, in a sub-hogel display all the polymerized LC elements can be patterned on a per sub-hogel basis effectively achieving achromaticity.

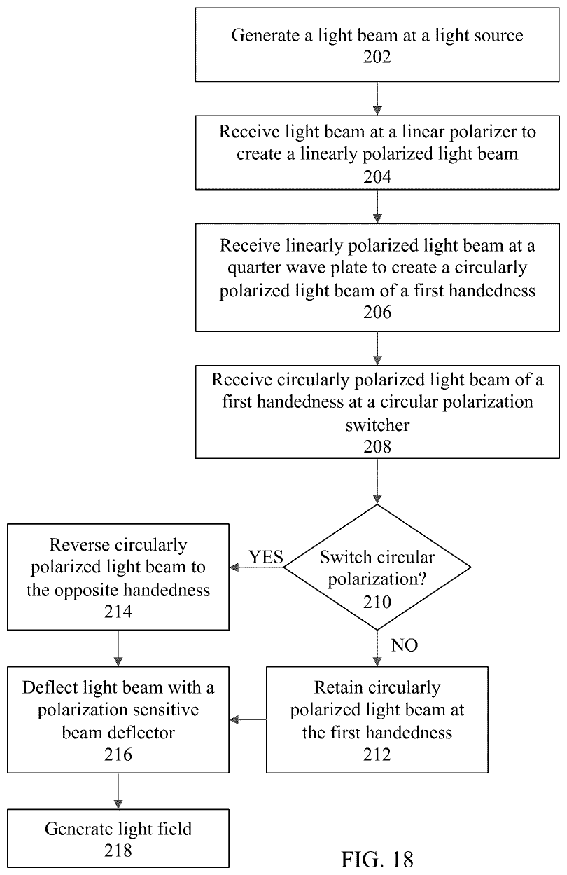

FIG. 18 is a flowchart illustrating a method of creating a time domain multiplexed light field display. As shown, a light field can be created by first generating a light beam from a source 202 and received at a linear polarizer to create a linearly polarized light beam 204. Alternatively, in a case where the input light is already polarized these preliminary linear polarization steps can be skipped. The linearly polarized light beam is then transmitted to a quarter wave plate, when combined with a linear polarizer, forms a circular polarizer, to transform the linearly polarized light beam to a circularly polarized light beam of a first handedness 206. The circularly polarized light beam of a first handedness is then transmitted to a circular polarization switcher 208, which can be a switchable half wave plate connected to a current source. If a switch in polarization is desired 210, a driver circuit in the circular polarization switcher can then be controlled to either transform the circularly polarized light beam of a first handedness to a circularly polarized light beam of a second handedness 214 or retain the circularly polarized light beam at the first handedness 212. In an embodiment of the disclosure, a control system controls the voltage to the driver circuit in the circular polarization switcher to switch or not switch the circular polarization of the incoming circularly polarized light beam 210.

Switchable waveplates or devices capable of altering the handedness of circular polarization can be created without the need for a direct voltage source. Various mechanisms exist to achieve this, which can leverage different stimuli such as thermal changes, magnetic fields, mechanical deformation, and optical or chemical control. One common alternative to electrical control is thermal responsiveness. Liquid crystals, for example, can change their orientation in response to temperature variations. By carefully managing heat, it is possible to create a waveplate with switchable properties, allowing for the adjustment of polarization handedness. This thermal control method offers a simple and effective way to manipulate circular polarization without electronic components. Magnetic fields also provide a means to control polarization. Magneto-optic materials are designed to change their optical properties under the influence of magnetic fields. By applying a magnetic field, these materials can rotate the polarization of light, enabling control over circular polarization and potentially allowing for handedness switching. Mechanical deformation presents another viable approach. Certain materials exhibit changes in their optical characteristics when subjected to mechanical strain or pressure. By using mechanical actuators to alter the orientation or birefringence of these materials, it is possible to create a switchable waveplate capable of changing the handedness of circular polarization. Optical control mechanisms can also be used to switch the polarization state. Nonlinear optical materials respond to high-intensity light, which can cause changes in their birefringence or polarization rotation characteristics. Similarly, photo-responsive materials can alter their properties when exposed to specific wavelengths of light, allowing for polarization switching. Both methods offer a high degree of precision and flexibility without the need for electronic control. Chemical control is another method to control polarization. Certain polymers can change their structure and optical properties in response to specific chemicals. By introducing these chemicals, the birefringence or other optical characteristics can be adjusted, providing a method to control polarization. Additionally, acoustic control involves using sound waves to modulate optical properties. Acousto-Optic devices generate acoustic waves that can alter the refractive index of materials. This approach allows for manipulation of polarization through mechanical vibrations, leading to polarization switching without direct electrical control. Each of these methods offers unique benefits and potential applications, from telecommunications to imaging and sensing. Depending on the desired outcome and environmental conditions, these techniques can be employed to create switchable waveplates or polarization-switching devices without relying on voltage sources.

If the system dictates not to switch the polarization, then the circularly polarized light beam is retained at the first handedness 212. Alternatively, if the system dictates to switch the polarization, then the handedness of the circularly polarized light beam is reversed to the opposite handedness 214. In a switchable half wave plate connected to a current source, the circularly polarized light beam of a first handedness is transformed to a circularly polarized light beam of a second handedness if the current source in an off state and retained in its original handedness if the current source is in an on state. In both cases the circularly polarized light is then transmitted to a polarization sensitive beam deflector configured to deflect the circularly polarized light beam of the first handedness by a first angle in a first direction and to receive light circularly polarized in the second handedness and deflect it by a second angle in a second direction. The deflected light is then transmitted to a directional optical element, for example a metasurface, to generate a light field.

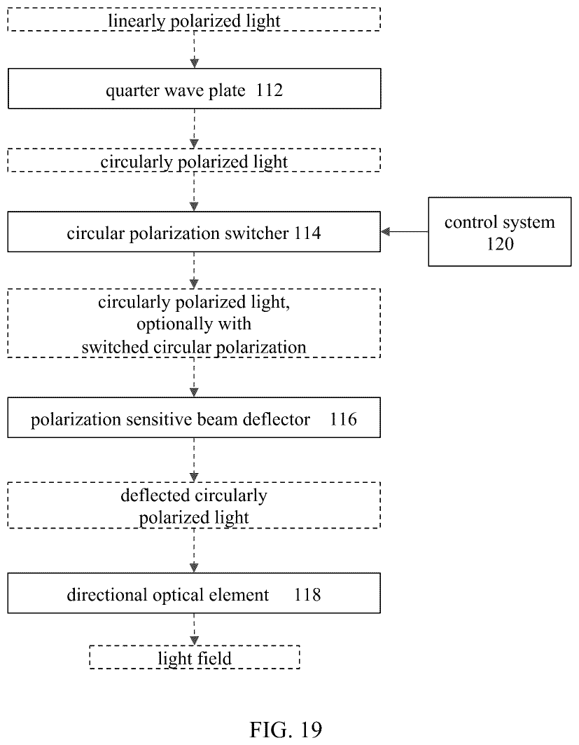

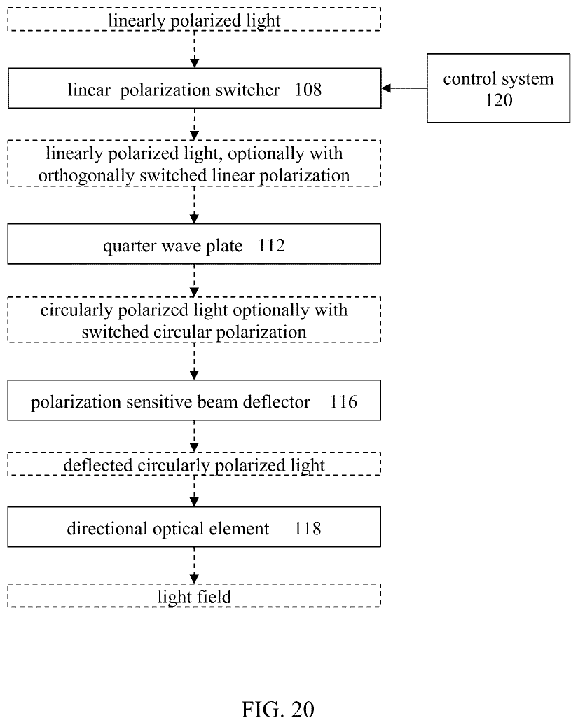

FIG. 19 illustrates components of a time division multiplexing device and transformation of the light by each component for an incoming polarized light source. The light phase is shown in dashed boxes and the optical components are shown in solid boxes. In the case where the incoming light is already polarized, the time domain multiplexing system converts the linearly polarized light into circularly polarized light with a quarter wave plate 112. A circular polarization switcher 114 can then optionally either retain or reverse the circular polarization of the circularly polarized light by application of a current controlled by a control system 120. A polarization sensitive beam deflector 116 deflects the circularly polarized light based on the handedness of the circularly polarized light by interaction with a polarization sensitive surface or material. Directional optical element 118 then directs the deflected light from a multitude of light sources to create a light field.

FIG. 20 illustrates components of a time division multiplexing device and transformation of the light by each component for an incoming linearly polarized light source with optional orthogonal linear polarization angle switching. The light phase is shown in dashed boxes and the optical components are shown in solid boxes. In the particular embodiment shown, an optional linear polarization switcher 108 may be positioned before the quarter wave plate 112 to optionally change the orthogonal orientation or state of the linearly polarized light. The linear polarization switcher 108 can take incoming linearly polarized light and orthogonally transform the linear polarization by 90° such that the plane of the linearly polarized light is orthogonally offset. The linear polarization switcher can also be thought of as being capable of accurately switching the plane of linearly polarized light by +/−45° in orthogonal linear polarizations. Some examples of linear polarization switchers include Electro-Optic Modulators (EOM), Liquid Crystal Devices (LCDs), Acousto-Optic Modulators (AOM), Magneto-Optic Modulators, Mechanical Polarization Switches, and Digital Polarization Rotators. Electro-Optic Modulators (EOM) include Pockels cells, which are a common type of EOM that uses the Pockels effect to alter the polarization state of light passing through it. By applying an electric field to the crystal in the Pockels cell, the refractive index changes, which in turn changes the polarization state of the light. Kerrs cells are similar to the Pockels cell, but instead uses the Kerr effect. Kerrs cells are typically used at higher field strengths compared to the Pockels cell. Liquid Crystal Devices (LCDs) include Liquid Crystal Polarization Rotators, which use the orientation of liquid crystals to rotate the polarization of light. The rotation angle can be controlled by applying an electric field, which changes the alignment of the liquid crystals. An Acousto-Optic Modulator (AOM) uses the interaction of light with sound waves in a medium to modulate the light's properties, including its polarization. By changing the frequency and amplitude of the acoustic waves, the polarization state of the light can be switched. A Magneto-Optic Modulator such as a Faraday Rotator utilizes the Faraday effect, where the polarization plane of light is rotated when it passes through a material under the influence of a magnetic field. The rotation angle depends on the strength of the magnetic field and the properties of the material. Mechanical Polarization Switches can include Rotating Wave Plates, Polarizing Beam Splitters with Motorized Rotators, Rotating Wave Plates, and Digital Polarization Rotators. In a Rotating Wave Plate a wave plate, such as a half-wave plate, is rotated to switch the polarization state. By mechanically rotating the wave plate to different angles, the polarization of the transmitted light can be altered. Polarizing Beam Splitters with Motorized Rotators use a combination of polarizing beam splitters and motorized rotators to change the polarization direction of the output beam. Digital Polarization Rotators are devices that use digital control to switch the polarization state. They often combine elements of electro-optic and liquid crystal technologies to achieve fast and precise control over the polarization.

These devices vary in terms of speed, efficiency, wavelength range, and control mechanisms, making them suitable for different applications and environments. In the case where the incoming light is not already polarized, a linear polarizer can also be positioned before the linear polarization switcher 108 to linearly polarize the incoming light. The time domain multiplexing system converts linearly polarized light into circularly polarized light with a quarter wave plate 112; the handedness of the transmitted circularly polarized light is determined by the polarization state of the income linear polarization. A polarization sensitive beam deflector 116 deflects the circularly polarized light based on the handedness of the circularly polarized light by interaction with a polarization sensitive surface or material. Directional optical element 118 then directs the deflected light from a multitude of light sources to create a light field.

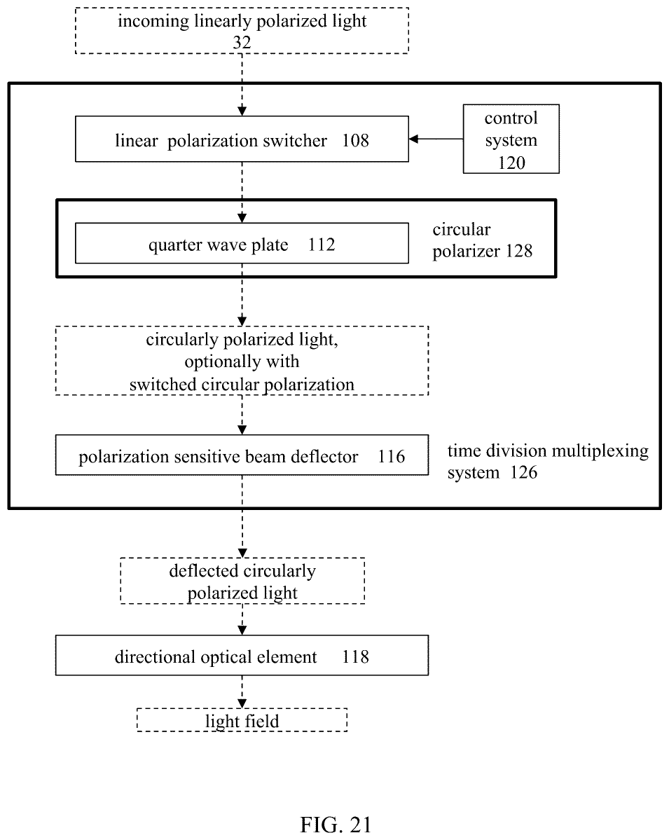

FIG. 21 illustrates components of a time division multiplexing device for incoming linearly polarized light and transformation of the light by each component. Incoming linearly polarized light 32 is received by the time division multiplexing system 126. Light is optionally first received by a linear polarization switcher 108 controlled by a control system 120 to retain or switch the orthogonal orientation of the linearly polarized light. A quarter wave plate 112 acts as a circular polarizer 128 converting the linearly polarized light to circularly polarized light 34; the handedness of the transmitted circularly polarized light is determined by the polarization state of the income linear polarization. A polarization sensitive beam deflector 116 deflects the circularly polarized light, which then interacts with directional optical element 118 to create a light field.

All publications, patents and patent applications mentioned in this specification are indicative of the level of skill of those skilled in the art to which this invention pertains and are herein incorporated by reference. The reference to any prior art in this specification is not, and should not be taken as, an acknowledgement or any form of suggestion that such prior art forms part of the common general knowledge.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A device for displaying a time multiplexed light field comprising:
a pixel array;
a time division multiplexing system; and
a directional optical element.

2. The device of claim 1, wherein the time division multiplexing system comprises a polarization sensitive optical system and a polarization sensitive beam deflector.

3. The device of claim 2, wherein the polarization sensitive optical system comprises:
a circular polarizer comprising a quarter wave plate for receiving incoming light and providing a circularly polarized light beam;
a circular polarization switcher comprising a switchable half wave plate; and
a control system for controlling current to the circular polarization switcher.

4. The device of claim 3, wherein the circular polarizer further comprises a linear polarizer before the quarter waveplate.

5. The device of claim 4, wherein the linear polarizer comprises an absorptive polarizer, beam-splitting polarizer, linear polarizing film, dichroic polarizer, wire grid polarizers, birefringent polarizer, or dichroic polymer thin film polarizer.

6. The device of claim 3, wherein the circular polarization switcher is a switchable liquid crystal half wave plate.

7. The device of claim 3, wherein the circular polarization switcher comprises a liquid crystal cell comprising:
a substrate;
a first electrode;
an alignment layer;
a liquid crystal material; and
a second electrode.

8. The device of claim 3, wherein the circular polarization switcher comprises a birefringent material selected from one of liquid crystals, quartz, and magnesium fluoride.

9. The device of claim 3, wherein the circular polarization switcher comprises a switchable liquid crystal half wave plate comprising a liquid crystal material comprising one or more of a birefringent material and a thermotropic material with a rod-like molecular shape.

10. The device of claim 2, wherein the polarization sensitive beam deflector comprises a birefringent material element, liquid crystal device, polarizing beam splitter, electro-optic or acousto-optic device, chromatic beam deflector, achromatic beam deflector, or Pancharatnam-Berry optical element.

11. The device of claim 1, wherein the directional optical element comprises one or more of a lens, lens array, mirror, prism, diffraction grating, waveguide, optical fiber, beam splitter, metasurface, and metalens.

12. The device of claim 4, wherein the linear polarizer is designed for maximum efficiency versus extinction ratio, p.

13. A method for creating a time multiplexed light field comprising:
receiving a light beam from a pixel array;
deflecting the light beam by a deflection angle; and
directing the deflected light beam at a directional optical element to generate a light field.

14. The method of claim 13, further comprising transforming the light beam received from the pixel array into a linearly polarized light beam.

15. The method of claim 13, further comprising transforming the linearly polarized light beam into a circularly polarized light beam having a rotational handedness.

16. The method of claim 15, further comprising, at a circular polarization switcher, reversing the rotational handedness of the circularly polarized light beam or retaining the rotational handedness of the circularly polarized light beam.

17. The method of claim 15, wherein the circularly polarized light beam is deflected and directed to the directional optical element to generate the light field.

18. The method of claim 13, wherein the deflection angle is based on a rotational handedness of the circularly polarized light beam.

19. The method of claim 13, wherein the deflected light beam shifts a virtual pixel position by a factor of one or more of one half of an angular pitch (Φ/2) and one quarter of the angular pitch (Φ/4) of pixels in the pixel array.

20. The method of claim 16, wherein the circular polarization switcher is a switchable liquid crystal half wave plate, and wherein retaining the rotational handedness comprises applying a threshold voltage to the switchable liquid crystal half wave plate sufficient to retain the handedness of the circularly polarized light beam.

21. The method of claim 17, wherein deflecting the circularly polarized light beam angle comprises receiving the circularly polarized light beam at a polarization sensitive beam deflector, the polarization sensitive beam deflector configured to deflect the circularly polarized light beam of a first handedness by a first angle in a first direction and to deflect the circularly polarized light beam of the reversed handedness by a second angle in a second direction.

22. The method of claim 13, wherein the light beam is received from a Light Emitting Diode (LED), projector device, Organic Light Emitting Diode (OLED), active-matrix organic light emitting diode (AMOLED) array, or electroluminescent (EL) device.

23. A time division multiplexing (TDM) optical system comprising:
a pixel array comprising a plurality of pixels, each pixel in the pixel array generating a light beam;
a circular polarizer comprising:
a linear polarizer for receiving the light beam and providing a linearly polarized light beam; and
a quarter wave plate for receiving the linearly polarized light beam and providing a circularly polarized light beam;
a circular polarization switcher for receiving the circularly polarized light beam and alternately switching between a first circularly polarized light beam of a first handedness and a second circularly polarized light beam of a second handedness, the circular polarization switcher connected to a control system to control current to the circular polarization switcher;
a polarization sensitive beam deflector configured to deflect the circularly polarized light based on its handedness; and
a directional optical element configured to receive the deflected circularly polarized light from the polarization sensitive beam deflector and generate a light field.

24. The optical system of claim 23, wherein the pixel array is in an active-matrix organic light emitting diode (AMOLED) array.

25. The optical system of claim 23, wherein the circular polarization switcher alternates between the circularly polarized light beam of the first handedness and the second circularly polarized light beam of the second handedness at least every 30 Hz.

26. The optical system of claim 23, wherein the polarization sensitive beam deflector comprises a birefringent material element, liquid crystal device, polarizing beam splitter, electro-optic or acousto-optic device, chromatic beam deflector, achromatic beam deflector, or Pancharatnam-Berry optical element.

27. The optical system of claim 23, wherein the polarization sensitive beam deflector is a controllable polarization sensitive beam deflector that can further control the deflection angle of the emitted light beam.

28. The optical system of claim 27, wherein the controllable polarization sensitive beam deflector is a controllable Pancharatnam-Berry (PB) beam deflector.

29. The optical system of claim 23, wherein the polarization sensitive beam deflector is connected to an electrical current source.

30. The optical system of claim 27, wherein the controllable polarization sensitive beam deflector is connected to an electrical current source.

31. The optical system of claim 23 further comprising a linear polarization switcher configured to receive and alter an orthogonal orientation of the linearly polarized light beam.

32. The optical system of claim 31, wherein the linear polarization switcher is an Electro-Optic Modulator (EOM), Liquid Crystal Device (LCDs), Acousto-Optic Modulator (AOM), Magneto-Optic Modulator, Mechanical Polarization Switch, or Digital Polarization Rotator.

33. The optical system of claim 31, wherein the linear polarization switcher switches a plane of linearly polarized light by +/−45°.

34. A time division multiplexing (TDM) optical system comprising:
a linear polarization switcher connected to a control system configured to receive a linearly polarized light beam and alternately switch between the linearly polarized light beam between a first orthogonal direction and a second orthogonal direction;
a quarter wave plate for receiving the linearly polarized light beam and providing a circularly polarized light beam;
a circular polarization switcher for receiving the circularly polarized light beam and alternately switching between a first circularly polarized light beam of a first handedness and a second circularly polarized light beam of a second handedness, the circular polarization switcher connected to a control system to control current to the circular polarization switcher;
a polarization sensitive beam deflector configured to deflect the circularly polarized light based on its handedness; and
a directional optical element configured to receive the deflected circularly polarized light from the polarization sensitive beam deflector and generate a light field.
